(19) United States
(12) Patent Application Publication
(10) Pub. No.: US 2025/0285058 A1
(43) Pub. Date: Sep. 11, 2025

(54) SYSTEMS, METHODS, AND SOFTWARE FOR ENHANCED RISK ASSESSMENT

(71) Applicant: Alessa Inc., Ottawa (CA)

(72) Inventors: Jeffrey David Woods, Austin, TX (US); Corie Murray, Orleans (CA); Sandip Chajjed, Ottawa (CA); Yazan Ahed Hussain, Ottawa (CA)

(21) Appl. No.: 19/073,827

(22) Filed: Mar. 7, 2025

Related U.S. Application Data
(60) Provisional application No. 63/562,958, filed on Mar. 8, 2024.

(51) Int. Cl. G06Q 10/0635

(52) U.S. Cl. CPC G06Q 10/0635

(57) ABSTRACT

Various examples disclosed herein relate to risk assessment and analysis of entities with respect to potential financial dealings. In an example embodiment, a risk assessment platform is provided that includes one or more computer-readable storage media and program instructions stored on the one or more computer-readable storage media that, based on being read and executed by a processing device, direct the processing device to perform various functions. Specifically, the program instructions direct the processing device to receive an input with an indication of a target entity, identify, based on the input, multiple possible instances of the target entity from a database, and for each possible instance of the multiple possible instances, evaluate a strength of a match of the possible instance to the target entity for display thereof on a graphical user interface.

### RELATED APPLICATIONS

This application claims the priority benefit of U.S. Application No. 63/562,958, filed Mar. 8, 2024, entitled “SCORING METHODOLOGY FOR POLITICALLY-EXPOSED-PERSONS,” which is hereby incorporated by reference in its entirety.

### TECHNICAL FIELD

This relates generally to risk assessment and analysis, and more particularly, to risk analysis computation hardware and software.

### BACKGROUND

Financial and non-financial institutions are required to screen various individuals or entities to minimize risk to the institutions and prevent financial crimes, such as money laundering, bribery, corruption, and terrorist financing. Screening helps institutions comply with global regulations and avoid legal, financial, and reputational risks. Failure to screen or proceeding to transact with high-risk individuals may result in penalties, loss of credibility, and even legal action.

Institutions often categorize individuals and entities by risk levels to adjust screening and compliance efforts accordingly. However, few solutions exist to accurately detect and categorize risk levels. Problematically, this may lead institutions to miss high-risk individuals and entities during screening exercises or unnecessarily screen lower-risk individuals and entities.

Despite filtering efforts to detect and review high-risk individuals and entities subject to higher review scrutiny, the amount of data to be screened is vast, often duplicative, and stored across several databases. As such, screening requires significant manual effort to obtain necessary records from the various sources, compile the records into consolidated profiles, and review the profiles for potential risks. Once the data is compiled and categorized, there may be numerous records that share the same name, geographical location, and roles, thus creating additional work to sift through false positive matches.

### SUMMARY

Disclosed herein are improvements to risk assessment, false positive detection, and risk analysis visualization of entities with respect to commercial dealings therewith. In an example embodiment, a risk assessment platform is provided that includes one or more computer-readable storage media and program instructions stored on the one or more computer-readable storage media that, based on being read and executed by a processing device, direct the processing device to perform various functions. Specifically, the program instructions direct the processing device to receive an input with an indication of a target entity subject to a risk assessment, identify, based on the input, multiple possible instances of the target entity from a database, and for each possible instance of the multiple possible instances, evaluate a strength of a match of the possible instance to the target entity for display thereof on a graphical user interface. The program instructions may also direct the processing device to display various visual representations on a graphical user interface, such as a visual representation of the multiple possible instances, corresponding strengths of matches, and threat confidence levels, among other information.

This Summary is provided to introduce a selection of concepts in a simplified form that are further described below in the Detailed Description. It may be understood that this Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example operating environment for performing risk assessment and analysis in accordance with some embodiments of the present technology.

FIG. 2A illustrates a series of steps for performing and displaying a risk assessment in accordance with some embodiments of the present technology.

FIG. 2B illustrates a series of steps for performing and displaying a false positive probability analysis in accordance with some embodiments of the present technology.

FIG. 3 illustrates an example sequence diagram demonstrating access and data flow between elements of a system in accordance with some embodiments of the present technology.

FIG. 4 illustrates an example block diagram of a risk assessment platform in accordance with some embodiments of the present technology.

FIGS. 5A, 5B, and 5C illustrate aspects of an example user interface associated with a risk assessment platform in accordance with some embodiments of the present technology.

FIG. 6 illustrates an aspect of an example user interface associated with a risk assessment platform in accordance with some embodiments of the present technology.

FIG. 7 illustrates an aspect of an example user interface associated with a risk assessment platform in accordance with some embodiments of the present technology.

FIGS. 8, 9, 10A, 10B, 11A, 11B, 12A, 12B, 13, 14A, 14B, 14C, 14D, and 15 illustrate example tables including configurable information used in risk analyses in accordance with some embodiments of the present technology.

FIG. 16 illustrates a computing device that may be used in accordance with some examples of the present technology.

The drawings are not necessarily drawn to scale. In the drawings, like reference numerals designate corresponding parts throughout the several views. In some examples, components or operations may be separated into different blocks or may be combined into a single block.

### DETAILED DESCRIPTION

Technology is disclosed herein that resolves the above issues with enhanced systems, methods, and software for risk assessment and analysis, threat detection, and false positive detection with respect to entities and financial dealings therewith. Risk-based screening techniques described herein relate to screening individuals and entities with a potential propensity to commit financial crimes, such as bribery, money laundering, and the like, screening transactions between individuals, entities, and institutions, and screening individuals and entities against alerts lists, like sanctions lists (e.g., OFAC, EU Sanctions, UN Sanctions), among other types of screening and risk analysis. Such screening processes help detect suspicious activities and high-risk transactions, prevent corruption and bribery, and protect financial institutions, non-financial institutions, and businesses from legal penalties, financial losses, and reputational damages.

In existing solutions, screening of individuals and entities, for example, is performed manually by obtaining various information about the individuals and entities, checking alerts and sanctions lists for notices associated with the individuals and entities, and identifying other individuals and entities connected to the individuals and entities subject to screening. The data is often spread across several databases making generating records for each individual or entity tedious. Some databases include the same or similar information as other databases, which may lead to the creation of duplicative or overlapping records for the individuals and entities, and ultimately, false positive records. Once an institution compiles a record(s) for an individual or entity, a user manually categorizes the record by a risk level.

High-risk records often requires enhanced due diligence meaning a user must perform extensive investigations into an individual's or entity's financial history, transaction patterns, connections, and source of funds.

To alleviate manual effort, reduce false positive records, and enhance the user experience with respect to screening processes, a risk assessment platform is described herein that accesses various databases, standardizes records and associated values obtained from the various databases, creates profiles for the individuals and entities subject to screening, and visualizes various aspects of the profiles, such as a threat confidence level and a false positive probability level. The threat confidence level associated with a profile may indicate a potential risk for suspicious or unlawful activity based on the individual's or entity's information, such as location, occupation, role, connections, and the like. The false positive probability level associated with a profile visually indicates to a user a strength of a match of a particular record relative to a queried name or identifier.

In an example embodiment, a risk assessment platform is provided that includes one or more computer-readable storage media and program instructions stored on the one or more computer-readable storage media that, based on being read and executed by a processing device, direct the processing device to perform various functions. Specifically, the program instructions direct the processing device to receive an input with an indication of a target entity subject to a risk assessment, identify, based on the input, multiple possible instances of the target entity from a database including a plurality of entities, and for each possible instance of the multiple possible instances, evaluate a strength of a match of the possible instance relative to the target entity based on applying a set of criteria against the indication of the target entity and comparing results of the application of the set of criteria with an indication of the possible instance. The program instructions may also direct the processing device to display, on a graphical user interface, a visual representation of the multiple possible instances and corresponding strengths of matches. Additionally, the program instructions may direct the processing device to, in response to a selection of one or more of the multiple possible instances, add the one or more of the multiple possible instances to a queue associated with a further risk assessment.

In another example embodiment, a risk assessment platform is provided that includes one or more computer-readable storage media and program instructions stored on the one or more computer-readable storage media that, based on being read and executed by a processing device, direct the processing device to perform various functions. Specifically, the program instructions direct the processing device to receive an input with an indication of a target entity subject to a risk assessment, and identify, based on the input, multiple possible instances of the target entity from a database including a plurality of entities. The program instructions also direct the processing device to display, on a graphical user interface, a visual representation of the multiple possible instances, corresponding strengths of matches relative to the target entity, and corresponding risk profiles. The program instructions also direct the processing device to, in response to a selection of a risk profile of one of the multiple possible instances, display, on the graphical user interface, a visual representation of a risk assessment generated for the risk profile based on performing a risk analysis on data associated with the risk profile accessed through one or more databases, wherein the visual representation of the risk assessment includes an indication of a threat confidence level associated with the risk profile.

In yet another example embodiment, a risk assessment system is provided that includes a memory, and a processor coupled with executable instructions forming modules of the risk assessment system and configured to execute the modules of the risk assessment system to produce a risk assessment. The modules executed by the processor include an input interface configured to obtain, from one or more databases, risk and governance data associated with an entity subject to the risk assessment, and obtain, from a user device, an input comprising an indication of a target entity, an output interface configured to output the risk assessment of the target entity, a data processing module configured to receive the risk and governance data associated with the target entity from the input interface and identify a subset of records having associated values, convert the values associated with the subset of records of the risk and governance data from a first format to a second format, and provide the converted values to a weight generation module, the weight generation module configured to receive the risk and governance data and the converted values from the data processing module, generate a set of weights for the risk and governance data, wherein the set of weights comprises a first subset of weights including the converted values, and a second subset of weights, and provide the set of weights to a scoring module, and the scoring module configured to generate the risk assessment of the target entity based on applying the set of weights to the risk and governance data and provide the risk assessment to the output interface.

Various embodiments of the present technology provide for a wide range of technical effects, advantages, and/or improvements to computing systems and components.

For example, various embodiments may include one or more of the following technical effects, advantages, and/or improvements: 1) entity record aggregation and standardization; 2) entity record indexing efficiency; 3) false positive detection accuracy and efficiency; 4) risk/threat level categorization accuracy and efficiency; 5) user experience and user interface enhancement with respect to at least false positive detection and risk/threat level identification; and 6) confirmation, dismissal, and enqueuing of entity records for further screening and risk assessment (e.g., enhanced due diligence) via automation, machine learning, and/or Artificial Intelligence.

In particular, the advantages of the technology disclosed herein include systems, methods, software, and devices for performing risk assessment and analysis based on personal, geographical, occupational, and financial data obtained from various sources. For institutions subject to screening regulations, the proposed solution can reduce the number of false positive records flagged for review, increase the accuracy with which records are categorized as requiring review, and improve the user experience related to screening, risk assessment, and risk analysis via automation and visualization.

While various embodiments of the present technology relate to screening individuals or entities, such as politically-exposed persons (PEPs), with respect to financial and commercial dealings, it may be appreciated that the systems, methods, software, and devices described herein may be utilized in other applications, such as in other types of financial screening applications, transaction screening applications, insurance screening applications, medical screening applications, and the like.

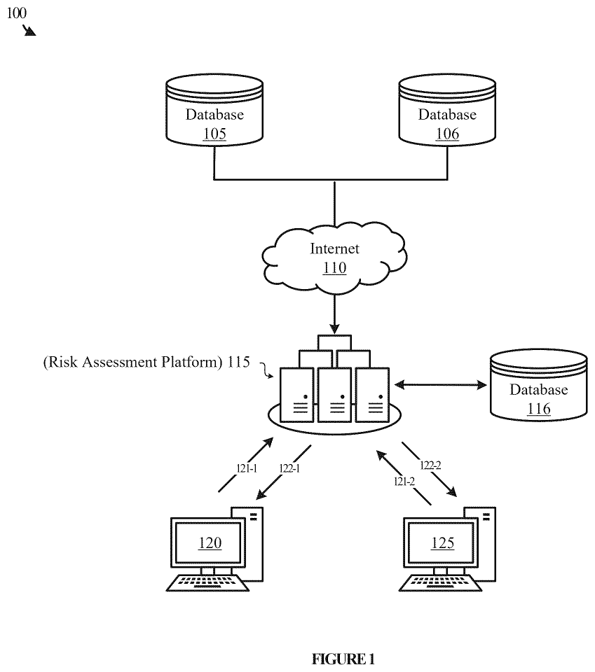

Moving now to the Figures, FIG. 1 illustrates an example operating environment for performing risk assessments and analyses in accordance with some embodiments of the present technology. FIG. 1 shows operating environment 100, which includes database 105, database 106, Internet 110, risk assessment platform 115, database 116, and user devices 120 and 125.

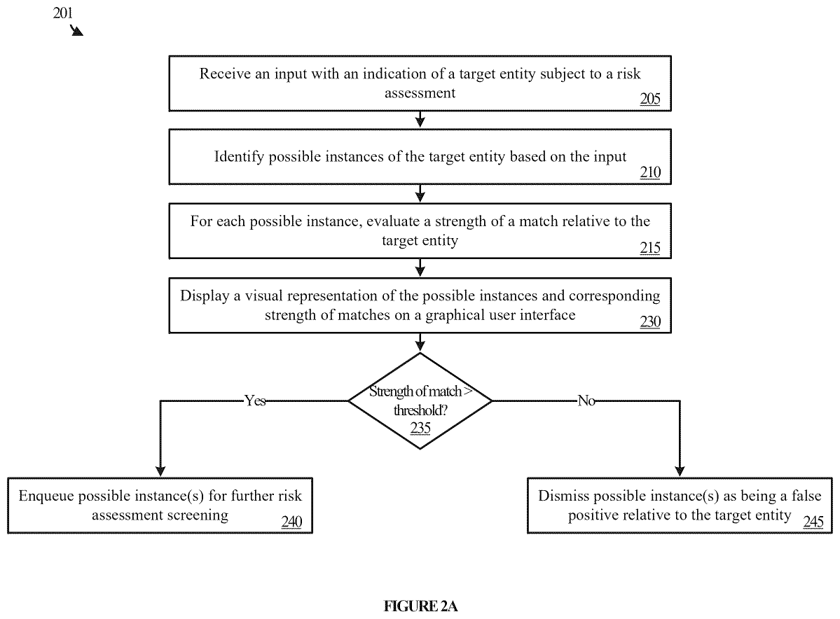

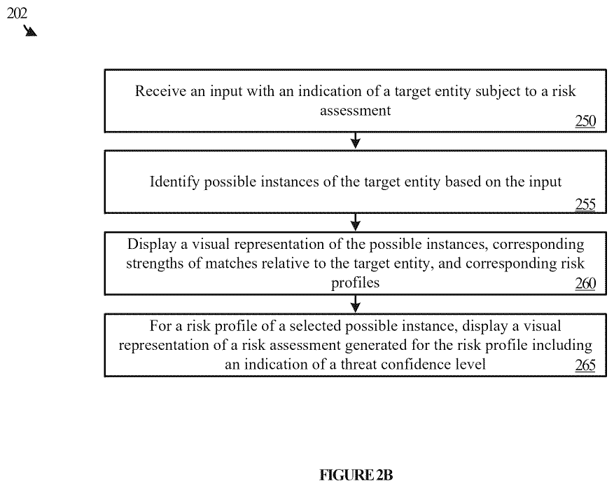

In various embodiments, risk assessment platform 115 is representative of a system, device, application, server, or the like capable of processing data from various databases, performing risk assessments and analyses, and outputting indications (e.g., visual, graphical) associated with risk assessments and analyses for entities (e.g., individuals, organizations) as requested by users. Risk assessment platform 115 may be configured to perform risk assessment and analysis operations, such as those of methods 201 and 202 of FIGS. 2A and 2B, respectively. As such, risk assessment platform 115 may be implemented in the context of software, hardware, and/or firmware, as well as combinations and variations thereof.

To perform risk assessments and analyses of entities, risk assessment platform 115 accesses databases 105 and 106 via respective interfaces and over a communication network (i.e., via Internet 110), and obtains data associated with entities from databases 105 and 106. Examples of the interfaces with which risk assessment platform 115 accesses databases 105 and 106 includes application programming interfaces (APIs), RESTful APIs, file transfer protocols (FTPs), and the like.

In various embodiments, database 105 is representative of a repository, data storage service, or another type of memory device that stores a first set of data associated with entities, such as corruption perception index (CPI) data. For example, database 105 may be a database hosted and provided by Transparency International, which may be accessible via Internet 110. The CPI data stored in database 105 may include data aggregated from a number of different sources that provide perceptions of businesspeople and country experts of the level of corruption in the public sector of various countries. In various embodiments, the CPI data may include data fulfilling criteria to quality as valid data. The criteria may include several factors related to whether the data source quantifies risks or perceptions of corruption in the public sector, bases data aggregation on a reliable and valid methodology, is a reputable organization, allows for sufficient variation of scores to distinguish between countries, ranks a substantial number of countries, considers only the assessments of country experts or businesspeople, and is regularly updated.

In various embodiments, the CPI data may include a list, table, or other data structure including country names, CPI scores associated with the countries, and ranks of the countries relative to one another. The CPI score may correspond to risk level. In database 105, the CPI scores may be provided on a 100% scale with corruption perception decreasing as the score increases. For example, in a previous report (2022 CPI Report), Denmark may have the highest CPI score with a score of 90, and thus, the lowest rank of 1 among all countries. Risk assessment platform 115 may obtain the CPI data and perform scoring standardization operations on the CPI data for use in scoring processes. More specifically, risk assessment platform 115 may normalize the CPI scores such that the highest score is set to a value of 0 and the lowest score is set to 100. Risk assessment platform 115 may use the following equation to normalize the CPI scores:

$$Normalized CPI Score = ( 1 - \frac{CPI Score - Minimum CPI Score}{Maximum CPI Score - Minimum CPI Score} ) \times 100$$

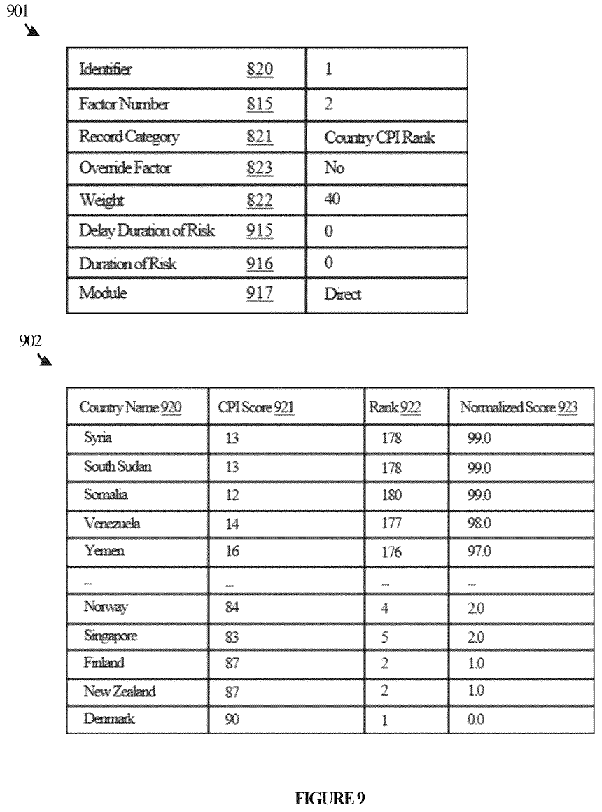

Examples of the CPI data, including CPI scores, country names, country ranks, and normalized CPI scores is shown and described in table 902 of FIG. 9.

Risk assessment platform 115 may further perform mapping processes to map CPI country codes to other naming conventions. For example, database 105 may include country names using a ISO3 code, and risk assessment platform 115 may obtain such codes from respective data fields, extract the codes from the data fields, map the codes to different fields with a different naming convention, and store the country names in database 116.

Database 106 may be representative of another database, data storage service, or another type of memory that stores data related to individuals or entities. For example, such data may include politically-exposed persons (PEP) data, financial transaction data, personal information, and connected entity data, among other information. In various embodiments, database 106 is a database hosted and provided by World-Check, Dow Jones, or Rzolut. The data stored in database 106 may include a number of individuals or entities, a unique identifier associated with each individual or entity, and a number of records associated with each individual or entity. Examples of the records include a date of birth (applicable for individuals), a gender (applicable for individuals), locations (e.g., place of birth, location of employment, location of residence, location of domicile), countries corresponding to nationality and/or citizenship, a classification or sub-classification, alert types, and the like. More specifically, the classifications may include various categories, or abbreviations thereof, such as non-governmental, national, subnational government, local, international organization, regional organization, state-owned organization, state-invested organization, and instrumentality of state. Some of the classifications may further include sub-classifications, such as close associate entity, close associate, and immediate relative. The alert types may include a number of categories, such as a law enforcement alert, a regulatory enforcement alert, a sanctions alert, a high-risk country alert, and other alerts. Each of the alert types may further include a sub-type, such as a linked entity alert.

In various embodiments, risk assessment platform 115 may be configured to obtain the data from database 106 and aggregate this data with the data obtained from database 105 to create an indexed data set. More particularly, risk assessment platform 115 can use the aggregated data to generate a profile for each individual and/entity identified including various personal, geographical, occupational, and other data.

To extract various records from the data obtained in database 106, risk assessment platform 115 may be configured to extract information from fields of the PEP data using one or more extraction functions. For example, risk assessment platform 115 may use the following extraction formula to obtain various records, such as place of birth:

$$extractall {(}^{′} \backslash \backslash s * ( {[}^{′} : \$ ] + ) {( ? : ; \vert \$ )}^{′} )$$

Other variations and combinations of extraction formulas may be used to obtain and aggregate records of the PEP data.

In some embodiments, database 106 may also include common name data that includes a list of common surnames for each of multiple ethnic groups. In some embodiments, the common name data may be obtained from a different database via a different interface. The common name data may include a list of the top 100 most common traditionally white or Caucasian last names, a list of the top 50 most common Asian last names, a list of the top 50 most common Hispanic last names, and a list of the top 30 most common Indian last names, among other lists. Upon aggregation of the common name data with the PEP data, risk assessment platform 115 may include an indication of whether the name of an individual matches a common last name found in one or more of the lists of the common name data. Risk assessment platform 115 can store the aggregated data in database 116, representative of a local or cloud database accessible by risk assessment platform 115 different from database 105 and database 106.

For each record in the aggregated data, such as the individual or entity name, the date of birth, the gender, the cities, states, countries, classifications, alert types, and the like, risk assessment platform 115 may be configured to determine a weight and a set of conditions or criteria against which to apply the records. A weight may include a value corresponding to a maximum score achievable if a record matches a condition. The set of conditions may include different threshold levels or direct matches. For example, risk assessment platform 115 may determine a weight for country records having a value of 40. If a risk profile includes the highest-risk country (e.g., based on the CPI data), risk assessment platform 115 may determine that the country record matches a high-risk country condition and award the maximum score for that weight (i.e., 40). If a risk profile includes a country that is not the highest-risk country, risk assessment platform 115 may determine that the country does not match the high-risk country condition, but instead matches a different risk condition, and may award a lesser score for that weight. If the condition is a direct match condition, risk assessment platform 115 may award 100% of the weight if the record includes a direct match or 0% of the weight if the record does not include a direct match.

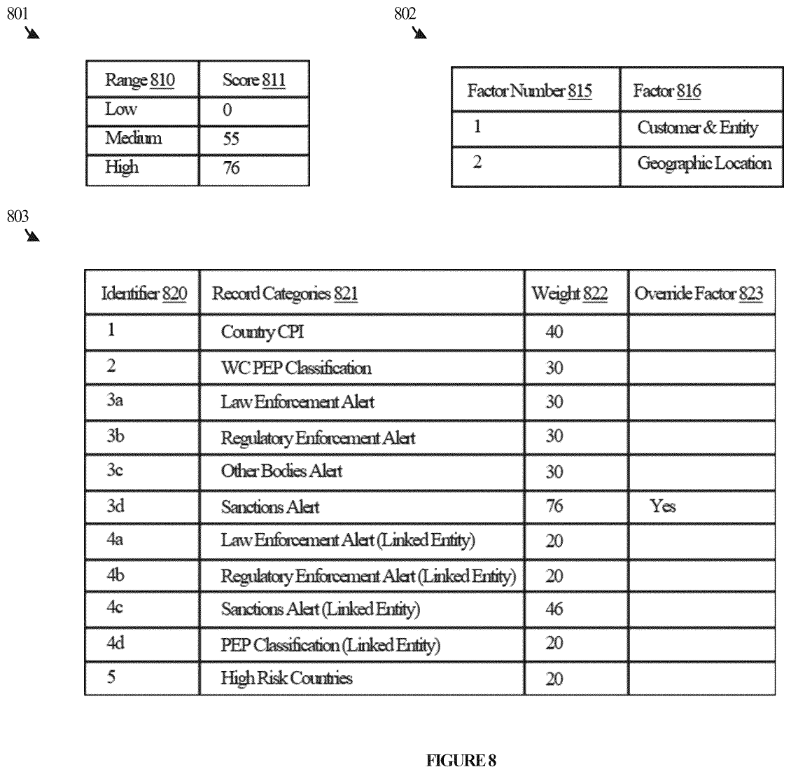

Risk assessment platform 115 may determine the weights based on a level of corruption or risk associated with the record. For example, risk assessment platform 115 may assign a weight with a high value for a sanctions alert and a weight with lower value for a law enforcement alert relative to the value of the sanctions alert weight as sanctions may be considered to be more high-risk with respect to PEPs and associated potential corruption. Sample values for the weights assigned to each record may be shown and described in table 803 of FIG. 8.

In some embodiments, risk assessment platform 115 may determine the weights based on a request from a user, such as request 121-1 from user device 120 (e.g., a computer, a tablet, a smart phone) or request 121-2 from user device 125 (e.g., a computer, a tablet, a smart phone). In such embodiments, a user of the user device may input custom weight values as part of the request, and risk assessment platform 115 may use the custom weight values for scoring operations and store the custom weights in database 116.

Risk assessment platform 115 may determine the conditions based on a complexity of the record. For example, risk assessment platform 115 may use a multi-level condition with different threshold levels for a record including multiple sub-categories or sub-classifications (e.g., PEP classification). On the other hand, risk assessment platform 115 may use a direct matching condition (e.g., an all-or-nothing condition) for a record including few options (e.g., a high-risk country record).

After determining the weights and corresponding conditions for the records, risk assessment platform 115 may be configured to, for each profile, apply the conditions against the records found in the profile, determine a value for each weight based on applying the conditions against the records, and generate a risk-based score based on the total of the values. Risk assessment platform 115 can compare the risk-based score to threshold scores and provide an indication of the risk-based score to a user device (e.g., user device 120) based on the risk-based score exceeding one or more of the threshold scores. The indication may include a status indicator, a pop-up alert, a message alert, or the like that can be displayed on a user interface of the user device.

Risk assessment platform 115 may also be configured to flag a record as an override factor. An override factor may correspond to the highest, or most important, risk record in the aggregated data, such that if a record flagged as an override factor exists in a profile, risk assessment platform 115 can award an amount of points that meets or exceeds a threshold score, and the profile can be indicated as high-risk despite the presence, or lack thereof, of other records in the profile.

By way of a first example, a user of user device 120 provides request 121-1 to risk assessment platform 115 for a risk assessment of one or more entities. Request 121-1 may include an indication of an entity, such as a name and/or a unique identifier (ID). Risk assessment platform 115 receives request 121-1, identifies one or more instances associated with the name and/or unique ID, and obtains the instances from database 116. Risk assessment platform 115 may identify the weights and conditions associated with the records of all the aggregated data, identify the records associated with the requested entity, and evaluate the identified records against the conditions to generate a threat confidence level associated with the requested profile based on the weights and conditions. Risk assessment platform 115 can then provide indication 122-1 to user device 120 for instantiation on a user interface thereof. Providing the risk-based score indication 122-1 to user device 120 may entail providing and/or displaying a notification or indication to user device 120, or a peripheral thereof (e.g., a screen, a speaker). The notifications or indications of risk-based score indication 122-1 may differ based on whether the risk-based score falls below, meets, or exceeds threshold scores.

In some examples, request 121-1 may include a name of an entity without a unique ID, and risk assessment platform 115 may identify multiple similar profiles based on request 121-1. In such examples, risk assessment platform 115 may obtain records for each of the similar profiles and evaluate the profiles against criteria to determine a strength of match for each profile relative to the request profile. In some embodiments, this may entail performing a comparison of records between a similar profile and the request profile to determine which is most similar (e.g., has the most matching records). In some embodiments, risk assessment platform 115 may assign weights to each record and apply the weights to identified records in the similar profiles as well as identified records in the request profile. Then, risk assessment platform 115 may compare the results of the application of the weights to determine a strength of match. Indication 122-1 may include an indication of the strength of match, such that a user of user device 120 may view visual or graphical indicators corresponding to probabilities of false positive profiles relative to the requested profile.

By way of a second example, a user of user device 125 provides request 121-2 to risk assessment platform 115 for a risk-based score of one or more entities. Request 121-2 may include a name of an entity, a unique identifier (ID) of the PEP, and a custom set of weights for each record, or record type, of the data. Risk assessment platform 115 may receive request 121-2, identify one or more profiles associated with the name and/or unique ID and obtain the profile from database 116. Risk assessment platform 115 may identify the weights and conditions associated with the records of all the aggregated data based on request 121-2, identify the records associated with the requested profile, and evaluate the identified records against the conditions to generate a threat confidence level based on the custom weights and conditions. Risk assessment platform 115 can then provide indication 122-2 to user device 125. The threat confidence level, and consequently indication 122-2, may differ from the threat confidence level and indication 122-1, respectively, based on differences between the sets of weights used by risk assessment platform 115. Advantageously, risk assessment platform 115 can provide dynamic risk-based scores based on weights that may be changed based on criteria a user determines to be important, risky, or the like when screening entities and analyzing risks thereof.

In some embodiments, risk assessment platform 115 may be configured to obtain data from respective databases, aggregate the data, and apply a set of weights and conditions to the data on a regular, automated basis. In some embodiments, however, risk assessment platform 115 may be configured to perform such operations in response to receiving a request. Other variations or combinations may be contemplated.

FIGS. 2A and 2B illustrate methods 201, and 202, respectively, which reference elements of operating environment 100 of FIG. 1. Method 201 of FIG. 2A illustrates a series of steps for performing and displaying a risk assessment in accordance with some embodiments of the present technology. FIG. 2B illustrates a series of steps for performing and displaying a false positive probability analysis in accordance with some embodiments of the present technology. Methods 201 and 202 may be implemented by risk assessment platform 115 of FIG. 1. Accordingly, methods 201 and 202 may be implemented in hardware, firmware, software, or combinations or variations thereof.

Referring first to method 201 of FIG. 2A, in operation 205, risk assessment platform 115 receives an input (e.g., request 121-1) from a user. The input includes an indication of a target entity subject to a risk assessment. More specifically, the indication may include a name of the target entity, an identifier associated with the target entity, a location associated with the target entity, a date of birth of the target entity, and other personal, occupational, and geographic information associated with the target entity. The user may provide the input to risk assessment platform 115 via a user interface of a user device (e.g., user device 120) in communication with risk assessment platform 115 over a communication network.

In operation 210, risk assessment platform 115 identifies possible instances of the target entity specified in the input. To do so, risk assessment platform 115 may first access one or more databases (e.g., database 105, database 106, database 116) and query the database(s) for records matching the indication of the target entity. For example, risk assessment platform 115 performs a query for the target entity using the name, identifier, and location of the target entity. The query results may include multiple entities that share the same or similar names, locations, and other identifying information. Some of these entities may be false positives, while others may correspond to the target entity.

Next, in operation 215, risk assessment platform 115 evaluates a strength of a match of each possible instance relative to the target entity. In various embodiments, this entails risk assessment platform 115 applying a set of criteria against the indication of the target entity, applying the set of criteria against an indication of a possible instance of the target entity, and comparing results of the application of the sets of criteria of the respective indications. The set of criteria includes sets of weights applicable to the records identified in the indications, such as personal information, geographical information, and occupational information. More specifically, a first set of weights corresponds to a commonness of a surname, and a second set of weights corresponds to a popularity of a domicile. Risk assessment platform 115 may assign a higher value for weights corresponding to popular surnames relative to unpopular surnames. Similarly, risk assessment platform 115 may assign a higher value for weights corresponding to popular, or more populated, countries relative to less populated countries. Risk assessment platform 115 accesses a database to obtain data corresponding to popular surnames and popular countries, then assigns weights to subsets of surnames and countries based on their commonness and popularity, respectively.

In some embodiments, the set of criteria also includes a third set of weights applicable to personal information missing from an indication of an entity. For example, risk assessment platform 115 assigns a value to a weight corresponding to a missing date of birth and a value to a weight corresponding to a missing gender. In this way, if an indication of an entity is missing either or both of these records, risk assessment platform 115 may take that into account. Other missing information may also be contemplated.

For the request target entity and each of the possibly related instances, risk assessment platform 115 identifies a surname, domicile, and other identifying information from respective indications. Risk assessment platform 115 applies the first set of weights to the surnames identified and the second set of weights to the domiciles identified to generate results. For any missing pieces of information, such as date of birth and gender, risk assessment platform 115 applies the third set of weights. Then, for each possible instance of the target entity, risk assessment platform 115 compares the results of the application of weights to records associated with the possible instance to the results of the application of weights to records included in the input query for the target entity. Risk assessment platform 115 generates a strength of a match to the target entity for each possible instance based on the comparison results.

In operation 230, risk assessment platform 115 displays a visual representation of the possible instances and corresponding strengths of matches on a user interface. In various embodiments, the visual representation of the possible instances illustrates various records associated with the possible instances, such as names, locations, and other identifying information, and the visual representation of the strengths of matches includes a graphical indicator (e.g., a bar, a colored marker) that illustrates a value or range of similarity between a given possible instance and the target entity. In various embodiments, risk assessment platform 115 includes a visualization module configured to obtain the indications of the possible instances and indications of the corresponding strengths of matches and convert such indications to a format readable and executable by a rendering engine of the user device displaying the user interface.

Optionally, in operation 235, risk assessment platform 115 identifies whether a strength of a match exceeds or falls below a threshold strength to automate a dismissal of a false positive match, and in turn, reduce the number of false positive instances a user must review advantageously eliminating manual effort and saving the user time. The threshold strength may include a value separating possible instances that have a high probability of being a false positive match from possible instances that have a lower probability of being a false positive match. For a strength of a match exceeding the threshold strength, in operation 240, risk assessment platform 115 enqueues a corresponding instance for further risk assessment screening. Contrarily, for a strength of a match below the threshold strength, in operation 245, risk assessment platform 115 dismisses a corresponding instance as being a false positive relative to the target entity.

In some embodiments, risk assessment platform 115 may include one or more machine learning models or Artificial Intelligence modules trained using training weights and sample enqueuing and dismissal patterns to automate and facilitate false positive detection processes, such as those of method 201. In such embodiments, risk assessment platform 115 can be iteratively trained with ground truth false positive data to improve detection of false positives based on similarities between records associated with possible instances of a target entity and the target entity. In some such embodiments, a user may initiate re-training or operation of the machine learning models via inputs to the user interface of the user device in communication with risk assessment platform 115 or running an instance of risk assessment platform 115.

Referring next to method 202 of FIG. 2B, in operation 250, risk assessment platform 115 receives an input (e.g., request 121-1) from a user. The input includes an indication of a target entity subject to a risk assessment. The indication may include a name of the target entity, an identifier associated with the target entity, a location associated with the target entity, a date of birth of the target entity, and other personal, occupational, and geographic information associated with the target entity. The user may provide the input to risk assessment platform 115 via a user interface of a user device (e.g., user device 120) in communication with risk assessment platform 115 over a communication network.

In operation 255, risk assessment platform 115 identifies possible instances of the target entity specified in the input. To do so, risk assessment platform 115 may first access one or more databases (e.g., database 105, database 106, database 116) and query the database(s) for records matching the indication of the target entity. For example, risk assessment platform 115 performs a query for the target entity using the name, identifier, and location of the target entity. The query results may include multiple entities that share the same or similar names, locations, and other identifying information. Some of these entities may be false positives, while others may correspond to the target entity.

Next, in operation 260, risk assessment platform 115 displays a visual representation of the possible instances, corresponding strengths of matches relative to the target entity, and corresponding risk profiles on a user interface. The evaluation processes for determining the strengths of matches between instances and the target entity is described above with respect to method 201 and is excluded here simply for the sake of brevity.

In various embodiments, the visual representation of the possible instances illustrates various records associated with the possible instances, such as names, locations, and other identifying information, and the visual representation of the strengths of matches includes a graphical indicator (e.g., a bar, a colored marker) that illustrates a value or range of similarity between a given possible instance and the target entity. The visual representation of the risk profiles also illustrates various records associated with the possible instances and additionally illustrates statuses associated with the possible instances, such as an open for review status, a closed review status, a dismissed status relative to a false positive, and more, and chat history associated with the possible instances. In various embodiments, risk assessment platform 115 includes a visualization module configured to obtain the indications of the possible instances, indications of the corresponding strengths of matches, and indications of the risk profiles and convert such indications to a format readable and executable by a rendering engine of the user device displaying the user interface.

In operation 265, for a risk profile of a possible instance selected by a user via an input to the user interface, risk assessment platform 115 displays a visual representation of a risk assessment generated for the risk profile including various graphical indicators, textual and numerical elements, and other information. For example, the visual representation of the risk assessment includes an indication of a threat confidence level associated with the selected possible instance. In various embodiments, the threat confidence level corresponds to a level of confidence of corruption with respect to performing financial transactions with the possible instance. In other words, this indicator may correlate to an entity's ability or propensity to engage in unlawful or suspicious activity with financial and non-financial institutions, businesses, or other individuals based on their geographic location, their occupation, their role, their connections to other individuals and entities, and the like.

To perform the risk assessment and determine the threat confidence level, risk assessment platform 115 accesses one or more databases (e.g., database 105, database 106, database 116) and obtains various records from the databases corresponding to the target entity and the possibly-related instances of the target entity. Risk assessment platform 115 identifies a subset of the obtained records that have values associated therewith from the source databases and converts the values from a first format to a second format to normalize the values to a single format. Risk assessment platform 115 generates a set of weights for the records, including a first set of weights that includes the converted values, and a second set of weights for other records without pre-existing values associated therewith. Then, risk assessment platform 115 applies the sets of weights to respective records to generate the threat confidence level.

In various embodiments, risk assessment platform 115 performs a comparison between the threat confidence level and a threshold threat level to determine whether the threat confidence level exceeds or falls below the threshold threat level. The threshold threat level may include a value separating low-risk profiles from higher risk profiles, which may require further risk assessment and analysis, such as enhanced due diligence. For a threat confidence level exceeding the threshold threat level, risk assessment platform 115 enqueues a corresponding risk profile for further risk assessment screening. Additionally, risk assessment platform 115 may provide an alert or notification to a user indicative of a high-risk profile. For a threat confidence level below the threshold threat level, risk assessment platform 115 updates the risk profile, or metadata thereof, to indicate that the risk profile is one of a lower risk than one requiring additional screening. Advantageously, automation of high-risk profile flagging and queueing can increase efficiency of initial screening reviews, conserve user time and manual effort, and reduce the probability of missing high-risk entities due to user error, for example. Additionally, the visual indications of high threat confidence levels, as well as notifications thereof, presented on a user interface to a user can improve the user experience and improve efficiency of the screening process.

In some embodiments, risk assessment platform 115 may include one or more machine learning models or Artificial Intelligence modules trained using training weights and sample threat confidence levels to automate and facilitate risk assessment and analysis processes, such as those of method 202. In such embodiments, risk assessment platform 115 can be iteratively trained with ground truth confidence threat level data to improve detection of high-risk profiles, as well as low and medium risk profiles for categorization purposes, based on similarities between records having higher risk scores than other records. In some such embodiments, a user may initiate re-training or operation of the machine learning models via inputs to the user interface of the user device in communication with risk assessment platform 115 or running an instance of risk assessment platform 115.

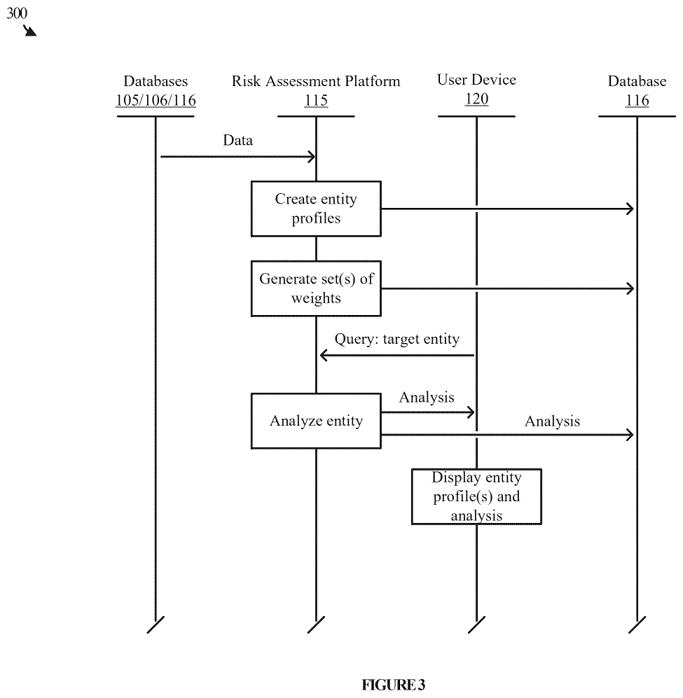

FIG. 3 illustrates an example sequence diagram demonstrating access and data flow between elements of a system in accordance with some embodiments of the present technology. FIG. 3 shows sequence 300, which references elements of operating environment 100 of FIG. 1. The series of operations shown in sequence 300 may be performed by risk assessment platform 115 of FIG. 1, and as such, may be implemented in hardware, software, and/or firmware, as well as combinations and variations thereof.

To begin sequence 300, risk assessment platform 115 obtains various data sets from multiple databases, such as databases 105, 106, and 116. By way of example, risk assessment platform 115 obtains entity data and common surname data from database 106 and corruption perception index (CPI) data from database 105. Risk assessment platform 115 additionally, or instead, obtains entity profile data (including entity data, previously generated threat confidence levels, etc.), weights, and other information from database 116.

In various embodiments, the CPI data may include a list, table, or other data structure including country names, CPI scores associated with the countries, and ranks of the countries relative to one another. The CPI score may correspond to risk level. The entity data may include a list, a table, or other data structure including a number of individuals or entities, a unique identifier associated with each individual or entity, and a number of records associated with each individual or entity. Examples of the records include a date of birth (applicable for individuals), a gender (applicable for individuals), locations (e.g., place of birth, location of employment, location of residence, location of domicile), countries corresponding to nationality and/or citizenship, a classification or sub-classification, alert types, and the like. More specifically, the classifications may include various categories, or abbreviations thereof, such as non-governmental, national, subnational government, local, international organization, regional organization, state-owned organization, state-invested organization, and instrumentality of state. Some of the classifications may further include sub-classifications, such as close associate entity, close associate, and immediate relative. The alert types may include a number of categories, such as a law enforcement alert, a regulatory enforcement alert, a sanctions alert, a high-risk country alert, and other alerts. Each of the alert types may further include a sub-type, such as a linked entity alert. Using the obtained data, risk assessment platform 115 creates an entity profile for each individual and/entity in the entity data if one does not already exist in database 116.

Risk assessment platform 115 also determines sets of weights and conditions against which to apply the records of a risk profile. For example, risk assessment platform 115 determines a first set of weights applicable to various records of the risk profile to generate a threat confidence level, and a second set of weights applicable to various records of the risk profile to generate a strength of match between a target entity profile and other similar entity records (also referred to as a false positive probability score).

In various embodiments, each weight of the first set of weights includes a value corresponding to a maximum score achievable if a record matches a condition. The set of conditions may include different threshold levels or direct matches. For example, risk assessment platform 115 may determine a weight for country records having a value of 40. If a risk profile includes the highest-risk country (e.g., based on the CPI data), risk assessment platform 115 may determine that the country record matches a high-risk country condition and award the maximum score for that weight (i.e., 40). If a risk profile includes a country that is not the highest-risk country, risk assessment platform 115 may determine that the country does not match the high-risk country condition but instead matches a different risk condition. As such, risk assessment platform 115 may award a lesser score for that weight. If the condition is a direct match condition, risk assessment platform 115 may award 100% of the weight if the record includes a direct match or 0% of the weight if the record does not include a direct match.

In various embodiments, each weight of the second set of weights includes values for a direct match of a common last name on one of the common last name lists of the common name data. For example, a weight of the second set of weights may include a value of 40. For a risk profile including a name that matches a name on one of the lists of the common name data, a maximum score of 40 may be determined based on the direct match for the name record.

In some embodiments, risk assessment platform 115 determines the weights based on a level of corruption or risk associated with the record. For example, risk assessment platform 115 assigns a weight with a high value for a sanctions alert, and a weight with lower value for a law enforcement alert relative to the value of the sanctions alert weight, as sanctions are considered to be more high-risk with respect to financial and commercial dealings and associated potential corruption and unlawfulness. In some such embodiments, risk assessment platform 115 obtains the weights from database 116. In some such embodiments, risk assessment platform 115 determines the weights based on a request from a user. For example, a user of user device 120 may input custom weight values as part of the request, and risk assessment platform 115 may use the custom weight values for scoring operations and store the custom weights in database 116.

In addition to custom weights, a request from user device 120 may identify one or more names and/or unique IDs associated with risk profiles. In response to receiving the request, risk assessment platform 115 identifies risk profile(s) associated with the names or identifiers, and applies the weights and conditions to the records of the risk profiles to generate a threat confidence level and a strength of match of the risk profiles relative to the queried name/identifier.

By way of example, for a risk profile identified from a search query, risk assessment platform 115 applies weights against the records found in the risk profile and generates the threat confidence level and strength of match for the risk profile. Risk assessment platform 115 may also compare the scores to threshold scores and provide indications of the scores to user device 120 based on either or both score exceeding respective threshold scores. The indications may include a status indicator, a pop-up alert, a message alert, or the like that can be displayed on a user interface of the user device. User device 120 may display the indications as well as an indication of the identified risk profile on a display of user device 120. A user of user device 120 may take actions based on the threat confidence level, such as reviewing the risk profile, flagging the risk profile for further action, resolving an action associated with the risk profile, and more, based on providing inputs to the user interface. Additionally, or alternatively, risk assessment platform 115 may perform some such actions automatically based on determining a threat confidence level above a respective threshold or a strength of match below a respective threshold.

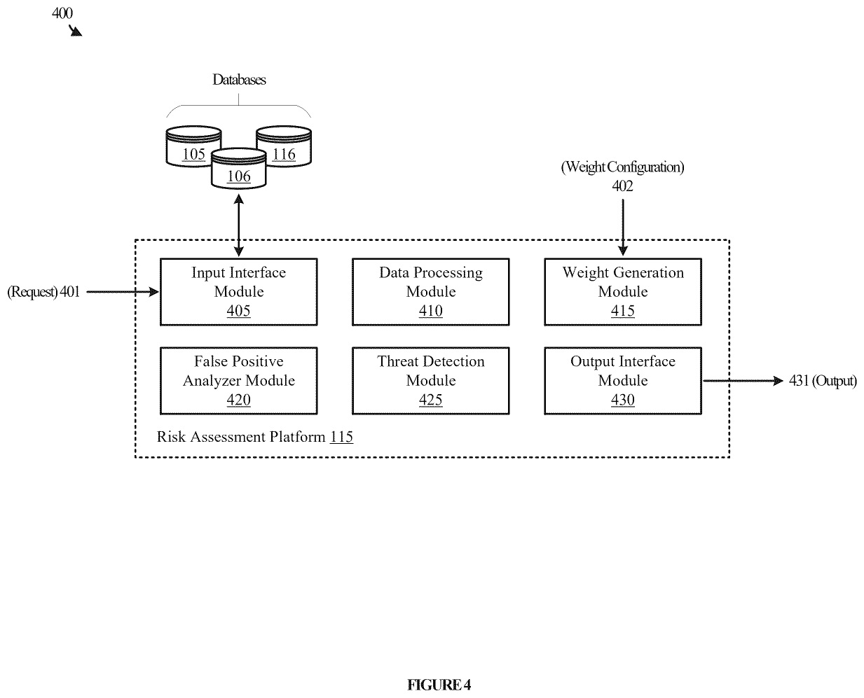

FIG. 4 illustrates an example block diagram of a risk assessment platform in accordance with some embodiments of the present technology. FIG. 4 includes operating environment 400, which includes risk assessment platform 115 and software modules thereof capable of performing risk assessment and analysis, threat detection, and false probability detection with respect to financial dealings with various entities. Risk assessment platform 115 and the software modules thereof may be configured to perform methods thereof, such as methods 200, 201, and 202 of FIGS. 2A, 2B, and 2C, respectively. In some embodiments, the modules of risk assessment platform 115 may additionally, or instead, be implemented in hardware and/or firmware, as well as combinations and variations of hardware, firmware, and software.

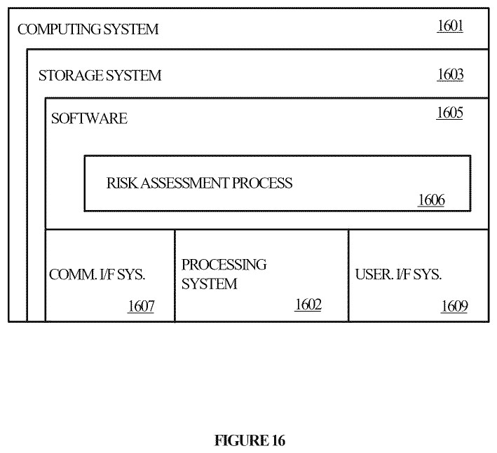

In operation, risk assessment platform 115 is configured to perform risk assessment and analysis operations as described above to determine information about various entities, determine a threat confidence level associated with the entities with respect to financial and commercial dealings, and determine how likely prospective entities resulting from an entity search are associated with a target entity that is the query of the search as opposed to a false positive entity. To enable such functionality, risk assessment platform 115 includes several software modules executable by a processing system of risk assessment platform 115, an example of which includes computing system 1601 of FIG. 16 shown and described below. The software modules include—but are not limited to—input interface module 405, data processing module 410, weight generation module 415, false positive analyzer module 420, threat detection module 425, and output interface module 430.

Input interface module 405 is representative of a software module configured to receive request 401 including an indication of a target entity subject to a risk assessment, access databases 105, 106, and 116 and obtain data corresponding to the target entity based on request 401, and provide data to other modules of risk assessment platform 115. The data obtained by input interface module 405 from the databases may include entity records (e.g., identifying information associated with the target entity), weights, criteria, and/or conditions applicable to entity records by other modules, and other risk assessment information.

Data processing module 410 is representative of a software module configured to identify a subset of the obtained records that have values associated therewith from the source databases and convert the values from a first format to a second format to normalize the values to a single format. Data processing module 410 provides the converted values and corresponding records to weight generation module 415.

Weight generation module 415 is representative of a software module configured to generate a set of weights for the records, including a first set of weights that includes the converted values, and a second set of weights for other records without pre-existing values associated therewith. Weight generation module 415 additionally, or instead, receives previously generated weights from a database via input interface module 405. Then, weight generation module 415 provides the weights to false positive analyzer module 420 and threat detection module 425.

False positive analyzer module 420 is representative of a software module configured to apply a subset of the weights to records of several possible instances of the target entity indicated in request 401. The query results returned from request 401 may include multiple entities that share the same or similar names, locations, and other identifying information. Some of these entities may be false positives, while others may correspond to the target entity. False positive analyzer module 420 evaluates a strength of a match of each possible instance relative to the target entity. In various embodiments, this entails false positive analyzer module 420 applying the subset of weights against the records identified in request 401 for the target entity, applying the subset of weights against records of a possible instance of the target entity, and performing a comparison of the results. A first subset of the weights corresponds to a commonness of a surname, and a second subset of the weights corresponds to a popularity of a domicile. Weight generation module 415 may assign a higher value for weights corresponding to popular surnames relative to unpopular surnames.

Similarly, weight generation module 415 may assign a higher value for weights corresponding to popular, or more populated, countries relative to less populated countries.

In some embodiments, the subset of weights also includes a third subset of weights applicable to personal information missing from an indication of an entity. For example, weight generation module 415 assigns a value to a weight corresponding to a missing date of birth and a value to a weight corresponding to a missing gender. In this way, if an indication of an entity is missing either or both of these records, false positive analyzer module 420 may take that into account. Other missing information may also be contemplated.

For the request target entity and each of the possibly related instances, false positive analyzer module 420 identifies a surname, domicile, and other identifying information from respective indications. False positive analyzer module 420 applies the first subset of weights to the surnames identified and the second subset of weights to the domiciles identified to generate results. For any missing pieces of information, such as date of birth and gender, false positive analyzer module 420 applies the third subset of weights. Then, for each possible instance of the target entity, false positive analyzer module 420 compares the results of the application of weights to records associated with the possible instance to the results of the application of weights to records included in the input query for the target entity. False positive analyzer module 420 generates a strength of a match to the target entity for each possible instance based on the comparison results, and provides the strengths of matches to output interface module 430.

Threat detection module 425 is representative of a software module configured to apply a subset of the weights from weight generation module 415 to records associated with the target entity (also collectively referred to as a risk profile of the entity) to generate a threat confidence level for the target entity's risk profile indicative of a likelihood that the entity is or will engage in unlawful financial dealings, such as bribery, money laundering, and the like.

In various embodiments, to generate the threat confidence level, To perform the risk assessment and determine the threat confidence level, threat detection module 425 applies a subset of weights to the records of the target entity. For example, threat detection module 425 may apply a first weight to a record indicative of the entity's domicile, a second weight to a record indicative of the entity's occupation, a third weight to a record indicative of the entity's political status, a fourth weight to a record indicative of the entity's political, regulatory, law enforcement, and occupational connections, a fifth weight to a record indicative of a presence of sanctions associated with the entity, and the like, as well as combinations and variations thereof based on the records present the risk profile for the entity. Threat detection module 425 combines the results of applying each weight to respective records to determine the threat confidence level and compares the threat confidence level to threshold threat levels to determine a threat classification (e.g., low risk, medium risk, high risk). Threat detection module 425 provides the threat confidence level and the threat classification to output interface module 430.

Output interface module 430 is representative of a software module configured to provide indications of the strengths of matches, threat confidence level, the risk profile and records thereof, the possible instances associated with the target entity and records thereof, and the like as output 431 to a user device for instantiation thereof on a user interface. In some embodiments, some such indications may also include alerts indicative of a high threat confidence level to notify a user of the user device as to a high risk entity.

In some embodiments, one or more modules of risk assessment platform 115, such as weight generation module 415, false positive analyzer module 420, and/or threat detection module 425 may include one or more machine learning models and/or Artificial Intelligence models capable of performing respective functions. More specifically, weight generation module 415 may include a machine learning model trained to generate new weights and corresponding values upon receiving a new record as input. The machine learning model may be trained on training data including sample weights and ground truth values for numerous entries to automate weight generation processes. By way of another example, false positive analyzer module 420 may include a machine learning model trained to identify and dismiss false positive entities to improve efficiency of the screening process and reduce manual effort required of a user. Such a machine learning model or AI model may be trained on training data including sample records and ground truth actions (e.g., confirm, dismiss). By way of yet another example, threat detection module 425 may include a machine learning model trained to identify, classify, and enqueue high-risk entities to improve efficiency of the screening process and reduce manual effort required of a user. Such a machine learning model or AI model may be trained on training data including sample records and ground truth actions (e.g., enqueue, dismiss).

It may be appreciated that risk assessment platform 115 may include fewer, additional, or different modules capable of performing similar risk assessment and analysis processes. Some capabilities of the modules of risk assessment platform 115 may be performed by different modules.

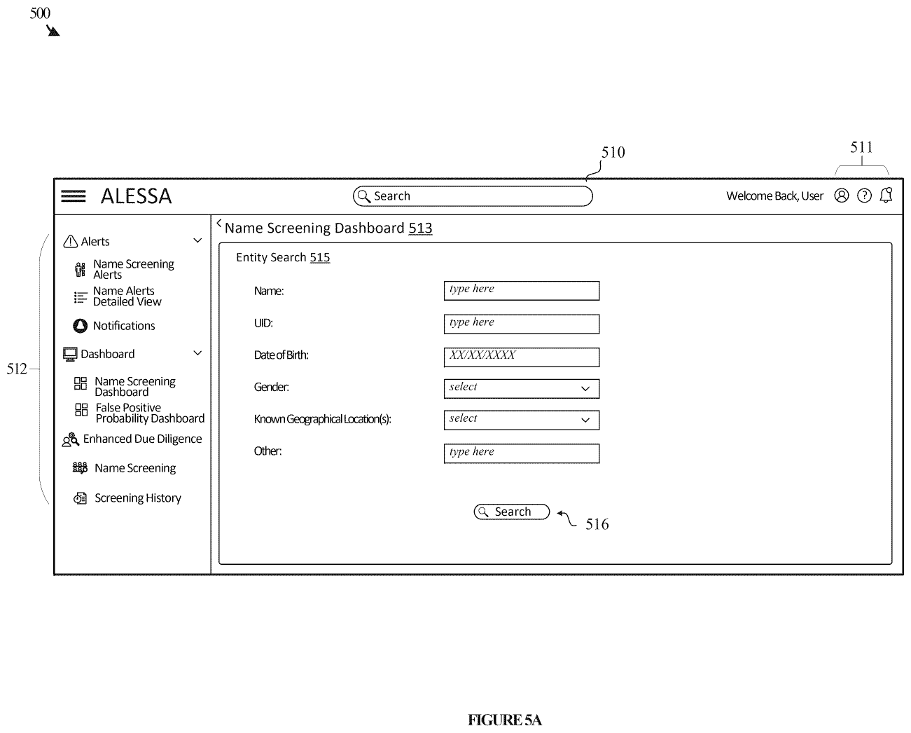

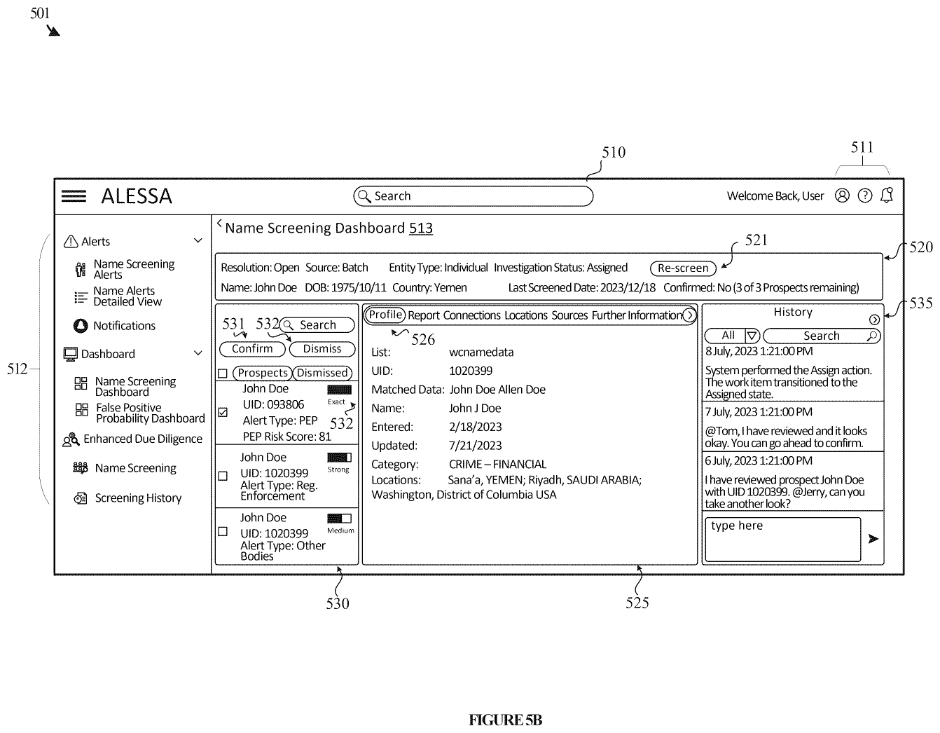

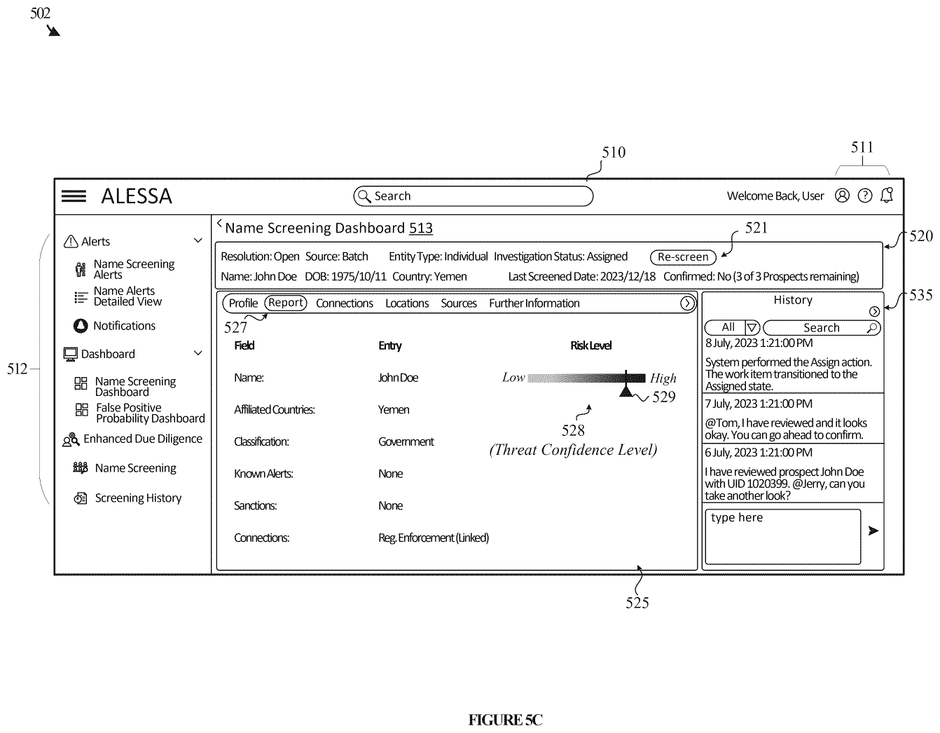

FIGS. 5A, 5B, and 5C illustrate aspects of an example user interface associated with a risk assessment platform in accordance with some embodiments of the present technology. More particularly, FIG. 5A includes aspect 500 of user interface 510, FIG. 5B includes aspect 501 of user interface 510, and FIG. 5C includes aspect 502 of user interface 510.

In various embodiments, user interface 510 is representative of a graphical user interface of a user device running or in communication with a risk assessment platform, such as risk assessment platform 115. User interface 510 may include various dashboards, toolbars, search bars, text boxes, icons, drop-downs, indications, and the like, with which a user of the user device may view, click, edit, or otherwise interact with the risk assessment platform. For example, user interface 510 includes account toolbar 511, functional toolbar 512, and a dashboard component capable of displaying different content based on an option selected via one of the elements of account toolbar 511 and functional toolbar 512. Account toolbar 511 may include a set of icons related to settings, help, account information, notifications, or other account-related functions. Functional toolbar 512 may include a set of icons related to different dashboards navigable on an application.

An example dashboard viewable via an element of functional toolbar 512 includes name screening dashboard 513 as shown in aspect 500 of FIG. 5A. Name screening dashboard 513 includes visual and textual indications corresponding to entity search 515 whereby a user can enter information about a target entity and search for the target entity according to the entered records via search button 516. Examples of the records enterable by a user via entity search 515 instantiated on name screening dashboard 513 include a name, a user identifier (UID), a date of birth, a gender, known geographical locations, and other information (e.g., known aliases, known connections, occupation). Additional, fewer, or different fields may be contemplated.

Upon submission of one or more of the records in entity search 515 via search button 516, the risk assessment platform accesses one or more databases to identify possible instances associated with the records and the target entity. The results obtained by the risk assessment platform in response to the entity search 515 may include multiple entities that share the same or similar names, locations, and other identifying information. Some of these entities may be false positives, while others may correspond to the target entity.

The risk assessment platform evaluates a strength of a match of each possible instance relative to the target entity. This may entail applying a set of criteria against the indication of the target entity, applying the set of criteria against an indication of a possible instance of the target entity, and comparing results of the application of the sets of criteria of the respective indications. For each of the possibly related instances, the risk assessment platform generates a strength of a match to the target entity and displays indications of the strengths of matches on name screening dashboard 513, as shown in aspect 501 of FIG. 5B.

Referring more specifically to aspect 501 of FIG. 5B, in this aspect, user interface 510 includes entity status window 520, risk assessment window 525, false positive identification window 530, and history window 535.

Entity status window 520 includes various indications related to status of a risk profile for a target entity queried via entity search 515, status of a review queue including possible instances related to the risk profile, and other status indicators. Entity status window 521 also includes a re-screen element 521 by which a user can refresh the information presented in entity status window 520 and risk assessment window 525, among other elements of name screening dashboard 513. Upon submission of a refresh by a user, the risk assessment platform may perform a new search for the target entity by accessing various databases and identifying associated records, and any updates thereto, for presentation on name screening dashboard 513.

Risk assessment window 525 includes various tabs that include indications of information associated with the risk profile of the target entity. As shown in aspect 501, user interface 510 shows profile view 526 on risk assessment window 525. Other tabs or views may be navigable by a user triggering the rendering and displaying of other information about the target entity.

Profile view 526 includes personal and geographical information about the risk profile of the target entity, such as a list or queue among which the risk profile belongs, a unique identifier of the risk profile, a name associated with the risk profile, a date on which the risk profile was created, a date on which the risk profile was last updated, a category to which the entity belongs, and country locations, among other information.

False positive identification window 530 may include indications of one or more possible instances of risk profiles related to the target entity, text descriptions about the instances, selection elements to view or interact with one or more of the instances profiles, and visualizations of strength of match to the target entity, such as strength of match indicator 532. In the example illustrated in aspect 501, false positive identification window 530 shows three risk profiles associated with the name “John Doe”. The first instance in the list may include strength of match indicator 532 indicative of an exact match to parameters requested by a user via entity search 515, which may be determined based on a false positive probability analysis performed by the risk assessment platform (e.g., method 201 of FIG. 2A). The second instance in the list may include a strength of match indicative of a strong match to parameters requested by the user. The third instance in the list may include a strength of match indicative of a medium match to parameters requested by the user.

The values of the strengths of matches, and corresponding indicators, may be determined by the risk assessment platform in response to the user requesting a search for the target entity. For example, upon inputting a search via search button 516, the risk assessment platform can identify the possible instances by comparing the records entered by the user to records obtained by the risk assessment platform from various databases. The risk assessment platform evaluates the possible instances against the target entity to determine a strength of match for each possible instance relative to the target entity. For a possible instance including many similar records as the ones entered by the user, the risk assessment platform may visualize the strength of match as an exact match as shown by strength of match indicator 532. For a possible instance including some similar records as the ones entered by the user, the risk assessment platform may visualize the strength of match as a strong match. For a possible instance including fewer records than a strong match, the risk assessment platform may visualize the strength of match as a medium match, and so on.

During a screening process, a user can view details about the possible instances via a selection element of false positive identification window 530. For any selected instances, a user can confirm the instance(s) as a match using confirm button 531 or dismiss the instance(s) as a false positive using dismiss button 532. Upon confirmation of an instance, the risk assessment platform may merge records of the instance with the target entity's risk profile. Upon dismissal of an instance, the risk assessment platform may update metadata associated with the instance to indicate that the instance is a false positive with respect to the target entity. Additionally, or alternatively, the risk assessment platform may remove the instance from a queue including records for screening.

History window 535 includes indications of previous activity related to the target entity, including status updates, textual updates entered or received by the user, and the like.

Moving next to aspect 502 of FIG. 5C, aspect 502 shows report view 527 within risk assessment window 525 of name screening dashboard 513. To navigate to report view 527 from another view of risk assessment window 525, a user may click, tap, or otherwise interact with the indication labeled “report” on user interface 510. In response to navigating to report view 527, the risk assessment platform performs a risk assessment on the target entity to populate report view 527 with information about the target entity including threat confidence level 528. Information displayed in report view 527 may include a name, affiliated countries, a classification, known alerts, sanctions, and connections associated with the target entity. Threat confidence level 528 includes a visual indication, such as a meter with a sliding scale indicator 529 as shown in aspect 502, indicative of a likelihood the target entity is or will engage in unlawful activity with respect to financial and commercial dealings.

In various embodiments, to perform the risk assessment and calculate threat confidence level 528, the risk assessment platform accesses the various databases and obtains records associated with the target entity, then applies weights to the records to generate threat confidence level 528. Details of such operations are discussed with respect to method 202 of FIG. 2B, and thus, are excluded here simply for the sake of brevity.

As shown in aspect 502, for the target entity, John Doe, the risk assessment platform determines a threat confidence level 528 having a high score as shown by sliding scale indicator 529. In various embodiments, for a high-risk entity, the risk assessment platform may enqueue the entity for further risk assessment and analysis. For lower-risk entities (e.g., entities having a threat confidence level 528 below a threshold threat level), the risk assessment platform might not add the entities to such a queue.

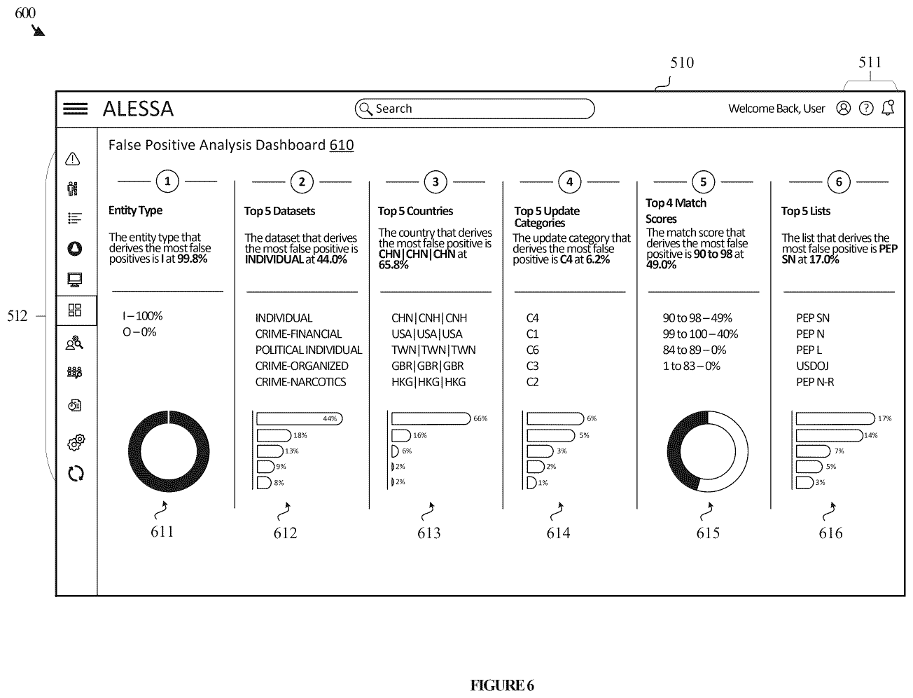

FIG. 6 illustrates another aspect of user interface 510 in accordance with some embodiments of the present technology. FIG. 6 shows aspect 600, which shows false positive analysis dashboard 610 of user interface 510.

False positive analysis dashboard 610 is representative of a view instantiated on user interface 510 by the risk assessment platform upon an input to functional toolbar 512. Upon an input to navigate to false positive analysis dashboard 610, the risk assessment platform generates various metrics related to false positives present in a user's data and displays graphical indications visualizing the corresponding metrics, such as visualizations 611, 612, 613, 614, 615, and 616.

For example, the risk assessment platform can determine a first set of metrics indicative of an entity type deriving the most false positive instances in the user's data. The risk assessment platform may determine the first set of metrics by applying false positive detection processes (e.g., method 201 of FIG. 2A) for numerous combinations and variations of target entities and determining a number of possible instances having strengths of matches below a threshold level (i.e., false positive instances). Then, the risk assessment platform may compute which searched entity type returns the most false positive instances. Based on the results, the risk assessment platform displays visualization 611 to convey the results in a graphical manner to the user on user interface 510.

The risk assessment platform may perform additional false positive analysis on a user's data to determine other sets of metrics and generate visualizations for the other sets of metrics. By way of another example, the risk assessment platform can determine a second set of metrics indicative a data set within a user's data (e.g., PEP classification data sets separated out by different PEP classification) that generates the most false positive instances. The risk assessment platform displays visualization 612 corresponding to results of a false positive detection process with respect to the second set of metrics. By way of another example, the risk assessment platform can determine a third set of metrics indicative a country within a user's data that generates the most false positive instances. The risk assessment platform displays visualization 613 corresponding to results of a false positive detection process with respect to the third set of metrics. The risk assessment platform may perform such analysis for a number of different metrics based on inputs to the risk assessment platform.

Advantageously, the risk assessment platform can detect problematic records in a user's data set yielding high numbers of false positives. False positives can increase manual effort as more records must be screened by a user, which reduces efficiency of the screening process, reduces storage capacity within databases, and reduces processing capacity as additional, unnecessary records may be returned during queries.

Additionally, user interface 510 enhances the user experience and screening process as the visualizations of information on user interface 510 can promote efficiency, ease of use, and convenience for users who may be required to screen hundreds or thousands of entities a day.

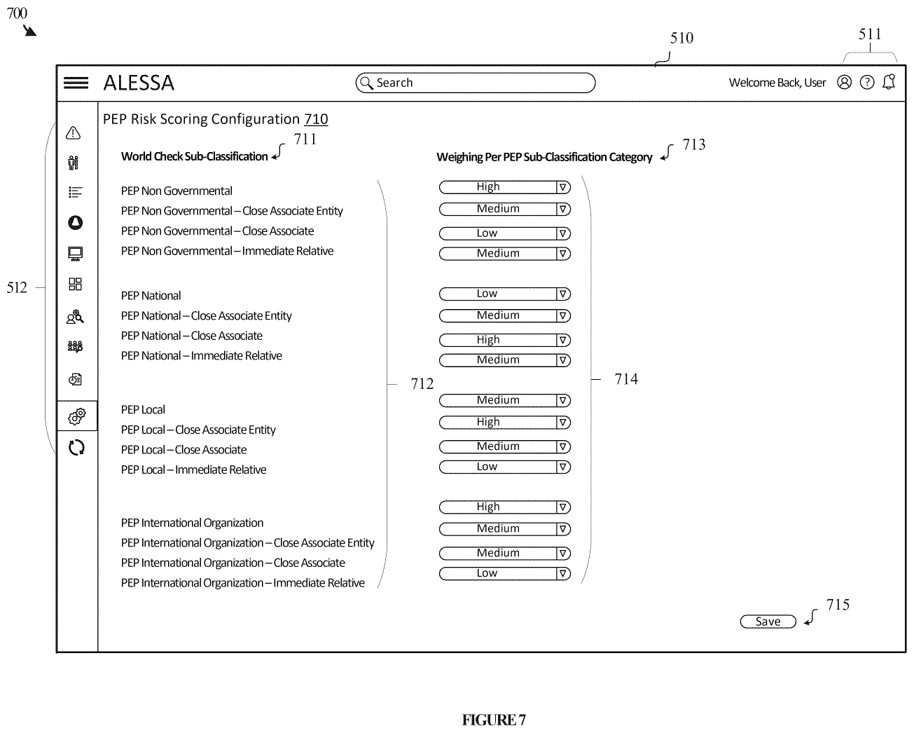

The following figures, FIGS. 7, 8, 9, 10A, 10B, 11A, 11B, 12A, 12B, 13, 14A, 14B, 14C, 14D, and 15 illustrate example aspects related to risk assessments and analysis of high-risk individuals and entities, such as politically-exposed persons (PEPs). More particularly, the following figures and related discussion correspond to specific embodiments involving risk and governance data, corruption perception data, linked entity data, and the like, as well as configurable sets of weights and values associated therewith, applicable to performing risk assessments and analyses on politically-exposed persons (PEPs). Other data, records, values, and weights may be contemplated in this context, as well as other contexts. Specifically, FIG. 7 relates to categories/classifications and associated weights configurable in a user interface (e.g., UI 510) for generation and instantiation of a risk assessment on the user interface as shown and described above, while FIGS. 8-15 includes tables with configurable information used in such risk assessments and analyses.

Generally, a PEP refers to an individual or an entity capable of being influenced financially based on a political status or political connection. Various institutions and companies track PEPs and compile data associated with PEPs, such as name, citizenship, domicile, residence, national origin, ethnicity, race, occupation, associations or connections, and the like as part of enhanced due diligence requirements. PEPs are screened by financial institutions and non-financial institutions and companies to determine levels of risk associated with the PEPs with respect to financially transacting with the PEPs.

Problematically, PEP data is often duplicative, overlapping, and unfilterable, which can lead to high amounts of false positives and significant manual effort on behalf of users (e.g., financial institution employees, cybersecurity and risk experts) to review. As disclosed herein, risk assessment techniques may be employed to generate risk assessments and analyses, including various confidence level scores, by applying configurable and dynamic weights against different records collected about entities, such as PEPs. Results of the assessments may be filtered and compared against threshold levels to provide condensed queues of risk profiles for review by a user. Advantageously, such techniques may not only reduce the number of PEPs in a review queue but also increase efficiency and accuracy when reviewing PEPs, as the number of false positives may be reduced (or at least visually indicated in a user interface, for example). Additionally, visual indicators, notifications, and alerts corresponding to high-risk PEPs may be presented in a user interface to facilitate review of PEPs and organize information typically spread out across several databases into an integrated dashboard view.

Referring now to FIG. 7, FIG. 7 illustrates an aspect of an example user interface associated with a risk assessment platform in accordance with some embodiments of the present technology. FIG. 7 shows user interface 510, which displays various elements and indications related to risk assessments.

In various embodiments, user interface 510 includes various dashboards, toolbars, search bars, text boxes, icons, drop-downs, indications, and the like, with which a user may view, click, edit, or otherwise interact. For example, user interface 510 includes account toolbar 511 and functional toolbar 512. User interface 510 also includes a dashboard component on which different content, based on an option selected via one of the elements of account toolbar 511 or functional toolbar 512, is rendered and displayed to the user. Account toolbar 511 may include a set of icons related to settings, help, account information, notifications, or other account-related functions. Functional toolbar 512 may include a set of icons related to different dashboards navigable on an application, such as a screening dashboard, risk assessment and analysis dashboard, and the like.

An example dashboard view selectable via functional toolbar 512 includes PEP risk scoring configuration 710 as shown in aspect 700 of FIG. 7. PEP risk scoring configuration 710 includes PEP classification list 711, weight configuration list 713, and a save component 715. PEP classification list 711 includes classifications 712 corresponding to a list of classifications defined by one or more organizations (e.g., World Check, Dow-Jones, Rzolut). In aspect 700, classifications 1114 includes the following classifications: PEP non-governmental, PEP non-governmental—close associate entity, PEP non-governmental—close associate, PEP non-governmental—immediate relative, PEP national, PEP national—close associate entity, PEP national—close associate, PEP national—immediate relative, PEP local, PEP local—close associate entity, PEP local—close associate, PEP local—immediate relative, PEP international organization, PEP international organization—close associate entity, PEP international organization—close associate, and PEP international organization—immediate relative. In some embodiments, additional, fewer, or different classifications, as well as combinations and variations thereof, may be contemplated.

Each classification may have a corresponding menu, one of configuration menus 714, by which a user can configure a weight assigned to a classification for risk assessment and analysis purposes. Examples of the configuration menus 714 may include drop-down menus, radio buttons, text boxes, and the like. In the example shown in aspect 700, configuration menus 714 include drop-down menus that each include options like high, medium, and low, which correspond to weight ranges or thresholds. By way of example, a high option selected for a classification may correspond to a higher, or more valuable, weight when applying the weights to records found for an entity. In some embodiments, a user may be able to enter in a custom value via the dashboard component of user interface 510 instead of, or in addition to, a selection via configuration menus 714.

In some embodiments, a user may select from default settings or may input weight ranges via configuration menus 714 for use by a risk assessment platform (e.g., risk assessment platform 115 of FIG. 1) in risk-based level computations. After selecting the weight ranges for each classification of PEP classification list 711, a user may save the selections via save component 715 of user interface 510. The selections may be saved to a database or memory location accessible by the risk assessment platform (e.g., database 116) via an interface coupling the risk assessment platform, the user device instantiating user interface 510, and the destination storage location.

Referring next to the tables illustrating example weight values and corresponding record classifications/categories, FIG. 8 illustrates example scoring tables and factors used in an implementation. FIG. 8 shows tables 801, 802, and 803, which may be used by a risk assessment, threat computation and false positive analysis system (e.g., risk assessment platform 115 of FIG. 1) to perform risk assessment and analysis techniques (e.g., methods 201 and 202 of FIGS. 2A and 2B, respectively).

Table 801 includes threshold ranges that may be used to categorize risk levels for a risk assessment in an embodiment. Table 801 includes range 810 and score 811. Range 810 includes a low range, a medium range, and a high range. The low range may include a score 811 between 0 and 54, the medium range may include a score 811 between 55 and 75, and the high range may include a score 811 of 76 and higher. Other ranges and scores may also be contemplated and used in risk assessment operations described herein.

Table 802 includes factors that may be considered when scoring individual or entity profiles (e.g., PEP profiles) and records thereof. Table 802 includes number 815 and factor 816. Number 1 corresponds to a first factor 816 titled Customer & Entity, and number 2 corresponds to a second factor 816 entitled “Geographic Location.” Other factors may also be contemplated and used in scoring operations described herein.

Table 803 shows a list of record categories 821 with associated IDs 820 and weights 822. The list may also include an indication of an override factor 823 that may be used to influence a risk level during a risk assessment operation. Number 1 under ID 820 may correspond to a record category titled Country CPI (where CPI stands for corruption perception index) that has a weight with a maximum value of 40. A record of a PEP profile that indicates one or more countries may be given a value between 0 and 40 based on CPI data obtained from a database (e.g., database 105). Number 2 under ID 820 may correspond to a record category titled PEP Classification that has a weight with a maximum value of 40. A record of a PEP profile that indicates a classification and/or sub-classification of the PEP (e.g., non-governmental, national, local) may be given a value between 0 and 30 based on PEP data obtained from a database (e.g., database 106). Number 3a under ID 820 may correspond to a record category titled Law Enforcement Alert that has a weight with a maximum value of 30. A record of a PEP profile that indicates a classification and/or sub-classification of the PEP corresponding to law enforcement may be given a value between 0 and 30 based on the obtained PEP data. Number 3b under ID 820 may correspond to a record category titled Regulatory Enforcement Alert that has a weight with a maximum value of 30. A record of a PEP profile that indicates a classification and/or sub-classification of the PEP corresponding to regulatory enforcement may be given a value between 0 and 30 based on the obtained PEP data. Number 3c under ID 820 may correspond to a record category titled Other Bodies Alert that has a weight with a maximum value of 30. A record of a PEP profile that indicates a classification and/or sub-classification of the PEP corresponding to other governmental bodies, agencies, or the like may be given a value between 0 and 30 based on the obtained PEP data. Number 3d under ID 820 may correspond to a record category titled Sanctions Alert that has a weight with a maximum value of 76. A record of a PEP profile that indicates a classification and/or sub-classification of the PEP corresponding to a sanction (e.g., a legal sanction) may be given a value between 0 and 76 based on the obtained PEP data.

As illustrated in table 803, override 823 may be indicated as “Yes” in association with ID 3d as a PEP having a record that indicates a sanction may be deemed as very high risk relative to other record categories 821. In some embodiments, the value of weight 822 for a record with override 823 indicated as “Yes” may be automatically set to meet or exceed the high range 810. Accordingly, the value of weight 822 may equal the minimum score 811 of table 801, such that when a PEP profile includes an indication of a record flagged with override 823, a scoring system may indicate the PEP profile as high risk. Number 4a under ID 820 may correspond to a record category titled Law Enforcement Alert (Linked Entity) that has a weight with a maximum value of 20. A linked entity may refer to a connection, either an individual or entity, of the person or entity identified in the PEP profile, such as a business associate or partner, a family relative, or the like. Thus, a record of a PEP profile that indicates a linked entity involved in a law enforcement agency may be given a value between 0 and 20 based on the obtained PEP data. Number 4b under ID 820 may correspond to a record category titled Regulatory Enforcement Alert (Linked Entity) that has a weight with a maximum value of 20. A record of a PEP profile that indicates a linked entity involved in a regulatory enforcement agency may be given a value between 0 and 20 based on the obtained PEP data. Number 4c under ID 820 may correspond to a record category titled Sanctions Alert (Linked Entity) that has a weight with a maximum value of 20. A record of a PEP profile that indicates a linked entity that has been sanctioned may be given a value between 0 and 46 based on the obtained PEP data. Number 4d under ID 820 may correspond to a record category titled PEP Classification (Linked Entity) that has a weight with a maximum value of 20. A record of a PEP profile that indicates a classification or sub-classification of a linked entity may be given a value between 0 and 20 based on the obtained PEP data. Number 5 under ID 820 may correspond to a record category titled High Risk Countries that has a weight with a maximum value of 20. A record of a PEP profile that indicates a high risk country (e.g., Russia, China) may be given a value between 0 and 20 based on the obtained PEP data.

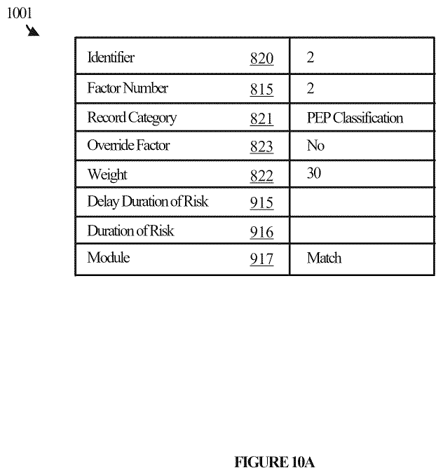

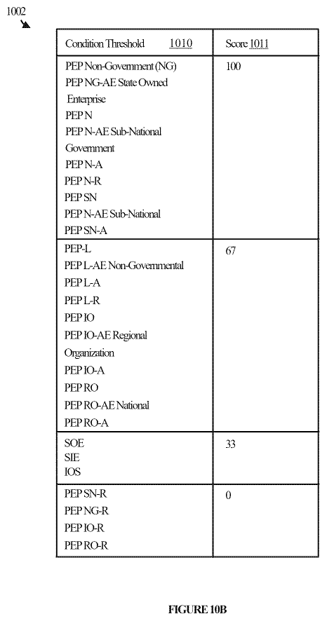

The following Figures, FIGS. 9, 10A-B, 11A-B, 12A-B, 13, and 14A-D, illustrate and describe further details related to the aforementioned IDs, record categories, and weights as described in FIG. 8.

FIG. 9 illustrates example scoring tables and factors used in an implementation.

FIG. 9 shows tables 901 and 902, which may be used by a scoring system (e.g., risk assessment platform 115) to perform risk-based scoring techniques (e.g., method 201, method 202).

Table 901 shows a list of parameters associated with the record category labeled number 1 under ID 820 of table 803 of FIG. 8. Accordingly, table 901 refers to record category 821 titled Country CPI. Country CPI may include a value of 1 for ID 820, a value of 2 for factor number 815 (i.e., a geographic location), an indication of no override 823, a value of 40 for weight 822, a value of 0 for delay duration of risk 915, a value of 0 for duration of risk 916, and a module 917 type of “direct”. Module 917 may refer to a condition type. In some embodiments, a direct condition type refers to a direct scoring method, meaning the value of weight 822 may be calculated based on a record found in the PEP profile and the Country CPI rank.

Table 902 shows a sample list of countries under country name 920, a respective CPI score 921, a respective rank 922, and a respective normalized score 923. As illustrated, table 902 includes Somalia under country name 920, which may have the highest rank 922 and normalized score 923, based on rank 922, and the lowest CPI score 921. Based on these numbers, a PEP profile that includes an indication of Somalia (i.e., a direct match) may receive the maximum value of weight 822 (40). Table 902 also includes Denmark under country 920, which may have the lowest rank 922 and normalized score 923, based on rank 922, and the lowest CPI score 921. Based on these numbers, a PEP profile that includes an indication of Denmark may receive the lowest value of weight 822 (0). Normalized score 923 may include a scaled value corresponding to a percentage of weight 822. In some embodiments, a scoring system may use normalized score 923 and the value of weight 822 to determine a score for Country CPI. To produce normalized score 923, a risk assessment platform (e.g., risk assessment platform 115) may identify values associated with country records from a database (i.e., CPI score 921) and convert the values from their original format to a different format standardized relative to other records and values obtained by the risk assessment platform. In this way, the risk assessment platform can apply weights to records in a standardized manner to simply risk level computations and false positive probability computations.

FIGS. 10A and 10B illustrate example scoring tables and factors used in an implementation. FIG. 10A shows table 1001, and FIG. 10B shows table 1002, both of which may be used by a scoring system (e.g., risk assessment platform 115) to perform risk-based scoring techniques (e.g., method 201, method 202).

Table 1001 of FIG. 10A shows a list of parameters associated with the record category labeled number 2 under ID 820 of table 803 of FIG. 8. Accordingly, table 1001 refers to record category 821 titled PEP Classification. PEP Classification may include a value of 2 for ID 820, a value of 2 for factor number 815, an indication of no override 823, a value of 30 for weight 822, a value of 0 for delay duration of risk 915, a value of 0 for duration of risk 916, and a module 917 type of “match”. In some embodiments, a match condition type refers to a matching scoring method, meaning the value of weight 822 may be calculated based on a direct match between a record found in the PEP profile and a PEP classification condition table (table 1002).

Table 1002 of FIG. 10B shows a list of PEP classifications and associated scores. Table 1002 includes a first group of PEP classifications in the first row under the first column of table 1002 titled condition threshold 1010. The PEP classifications included in the first group may include non-governmental PEPs, national PEPs, subnational PEPs, and more. This first group may correspond to score 1011 of 100. In other words, if a PEP profile includes an indication of a PEP classification in the first group, a scoring system may award 100% of the value of weight 822 (i.e., 30) based on module 917. Table 1002 also includes a second group of PEP classifications in the second row under condition threshold 1010. The PEP classifications included in the second group may include close associate linked entities, international organizations, regional organizations, and more. The second group may correspond to score 1011 of 67. In other words, if a PEP profile includes an indication of a PEP classification in the second group, a scoring system may award 67% of the value of weight 822 (i.e., 20). Table 1002 also includes a third group of PEP classifications in the third row under condition threshold 1010. The PEP classifications included in the third group may include state-owned organizations, state-invested organizations, and instrumentalities of a state, and more. The third group may correspond to score 1011 of 33. In other words, if a PEP profile includes an indication of a PEP classification in the third group, a scoring system may award 33% of the value of weight 822 (i.e., 10). Table 1002 further includes a fourth group of PEP classifications in the fourth row under condition threshold 1010. The PEP classifications included in the fourth group may include immediate relatives of various classifications. The fourth group may correspond to score 1011 of 0. In other words, if a PEP profile includes an indication of a PEP classification in the fourth group, a scoring system might not award any score of weight 822. Other groupings and score breakdowns may be contemplated.

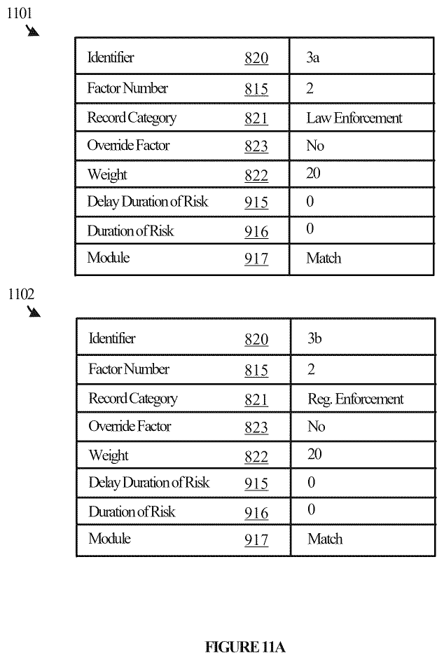

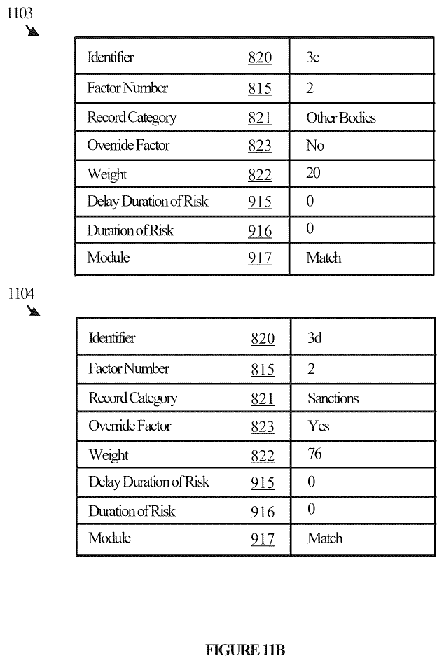

FIGS. 11A and 11B illustrate example scoring tables and factors used in an implementation. FIG. 11A shows tables 1101 and 1102, and FIG. 11B shows table 1103 and 1104, each of which may be used by a scoring system (e.g., risk assessment platform 115) to perform risk-based scoring techniques (e.g., method 201, method 202).

Table 1101 of FIG. 11A shows a list of parameters associated with the record category labeled number 3a under ID 820 of table 803 of FIG. 8. Accordingly, table 1101 refers to record category 821 titled Law Enforcement Alert. This category may include a value of 3a for ID 820, a value of 2 for factor number 815, an indication of no override 823, a value of 20 for weight 822, a value of 0 for delay duration of risk 915, a value of 0 for duration of risk 916, and a module 917 type of “match”.

Table 1102 of FIG. 11A shows a list of parameters associated with the record category labeled number 3b under ID 820 of table 803 of FIG. 8. Accordingly, table 1102 refers to record category 821 titled Regulatory Enforcement Alert. This category may include a value of 3b for ID 820, a value of 2 for factor number 815, an indication of no override 823, a value of 20 for weight 822, a value of 0 for delay duration of risk 915, a value of 0 for duration of risk 916, and a module 917 type of “match”.

Table 1103 of FIG. 11B shows a list of parameters associated with the record category labeled number 3c under ID 820 of table 803 of FIG. 8. Accordingly, table 1103 refers to record category 821 titled Other Bodies Alert. This category may include a value of 3c for ID 820, a value of 2 for factor number 815, an indication of no override 823, a value of 20 for weight 822, a value of 0 for delay duration of risk 915, a value of 0 for duration of risk 916, and a module 917 type of “match”.

Table 1104 of FIG. 11B shows a list of parameters associated with the record category labeled number 3d under ID 820 of table 803 of FIG. 8. Accordingly, table 1104 refers to record category 821 titled Sanctions Alert. This category may include a value of 3d for ID 820, a value of 2 for factor number 815, an indication of override 823, a value of 76 for weight 822, a value of 0 for delay duration of risk 915, a value of 0 for duration of risk 916, and a module 917 type of “match”.

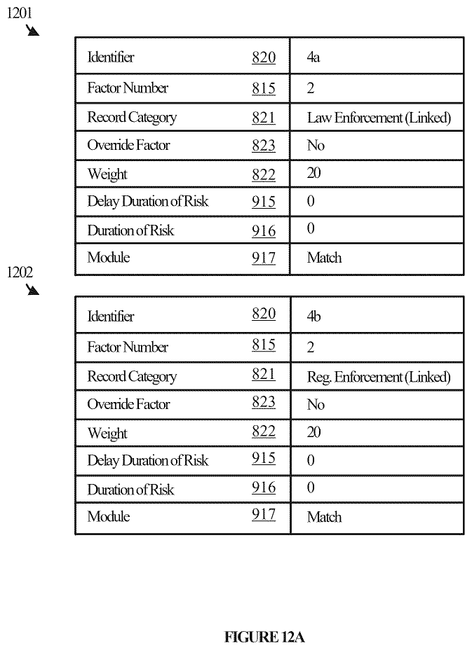

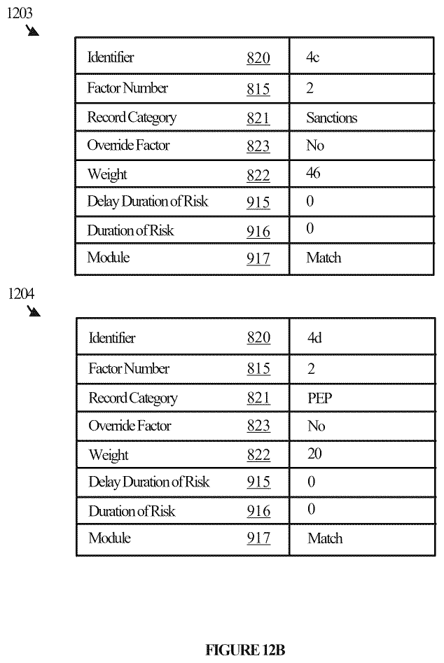

FIGS. 12A and 12B illustrate example scoring tables and factors used in an implementation. FIG. 12A shows tables 1201 and 1202, and FIG. 12B shows table 1203 and 1204, each of which may be used by a scoring system (e.g., risk assessment platform 115) to perform risk-based scoring techniques (e.g., method 201, method 202).

Table 1201 of FIG. 12A shows a list of parameters associated with the record category labeled number 4a under ID 820 of table 803 of FIG. 8. Accordingly, table 1201 refers to record category 821 titled Law Enforcement Linked Entity Alert. This category may include a value of 4a for ID 820, a value of 2 for factor number 815, an indication of no override 823, a value of 20 for weight 822, a value of 0 for delay duration of risk 915, a value of 0 for duration of risk 916, and a module 917 type of “match”.

Table 1202 of FIG. 12A shows a list of parameters associated with the record category labeled number 4b under ID 820 of table 803 of FIG. 8. Accordingly, table 1202 refers to record category 821 titled Regulatory Enforcement Linked Entity Alert. This category may include a value of 4b for ID 820, a value of 2 for factor number 815, an indication of no override 823, a value of 20 for weight 822, a value of 0 for delay duration of risk 915, a value of 0 for duration of risk 916, and a module 917 type of “match”.

Table 1203 of FIG. 12B shows a list of parameters associated with the record category labeled number 4c under ID 820 of table 803 of FIG. 8. Accordingly, table 1203 refers to record category 821 titled Sanctions Linked Entity Alert. This category may include a value of 4c for ID 820, a value of 2 for factor number 815, an indication of no override 823, a value of 46 for weight 822, a value of 0 for delay duration of risk 915, a value of 0 for duration of risk 916, and a module 917 type of “match”.

Table 1204 of FIG. 12B shows a list of parameters associated with the record category labeled number 4d under ID 820 of table 803 of FIG. 8. Accordingly, table 1204 refers to record category 821 titled PEP Classification. This category may include a value of 4d for ID 820, a value of 2 for factor number 815, an indication of no override 823, a value of 76 for weight 822, a value of 0 for delay duration of risk 915, a value of 0 for duration of risk 916, and a module 917 type of “match”.

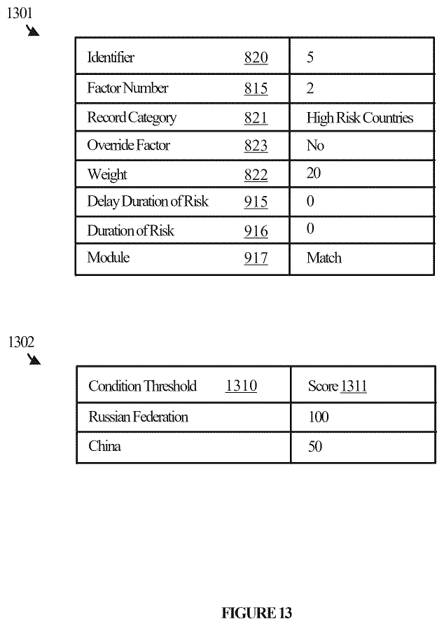

FIG. 13 illustrates example scoring tables and factors used in an implementation. FIG. 13 shows tables 1301 and 1302, which may be used by a scoring system (e.g., risk assessment platform 115) to perform risk-based scoring techniques (e.g., method 201, method 202).

Table 1301 of FIG. 13 shows a list of parameters associated with the record category labeled number 5 under ID 820 of table 803 of FIG. 8. Accordingly, table 1301 refers to record category 821 titled High Risk Countries. This category may include a value of 5 for ID 820, a value of 2 for factor number 815, an indication of no override 823, a value of 20 for weight 822, a value of 0 for delay duration of risk 915, a value of 0 for duration of risk 916, and a module 917 type of “match”.

Table 1302 of FIG. 13 shows a list of high risk countries and associated scores. Table 1302 includes a first group of high risk countries in the first row under the first column of table 1302 titled condition threshold 1310. The first group may include the Russian Federation, among other countries. This first group may correspond to score 1311 of 100. In other words, if a PEP profile includes an indication of the Russian Federation, a scoring system may award 100% of the value of weight 822 (i.e., 20) based on module 917. Table 1302 includes a second group of high risk countries in the second row under the first column of table 1302 titled condition threshold 1310. The second group may include China, among other countries. This second group may correspond to score 1311 of 50. In other words, if a PEP profile includes an indication of China, a scoring system may award 50% of the value of weight 822 (i.e., 10) based on module 917. Other countries and scores may be contemplated.

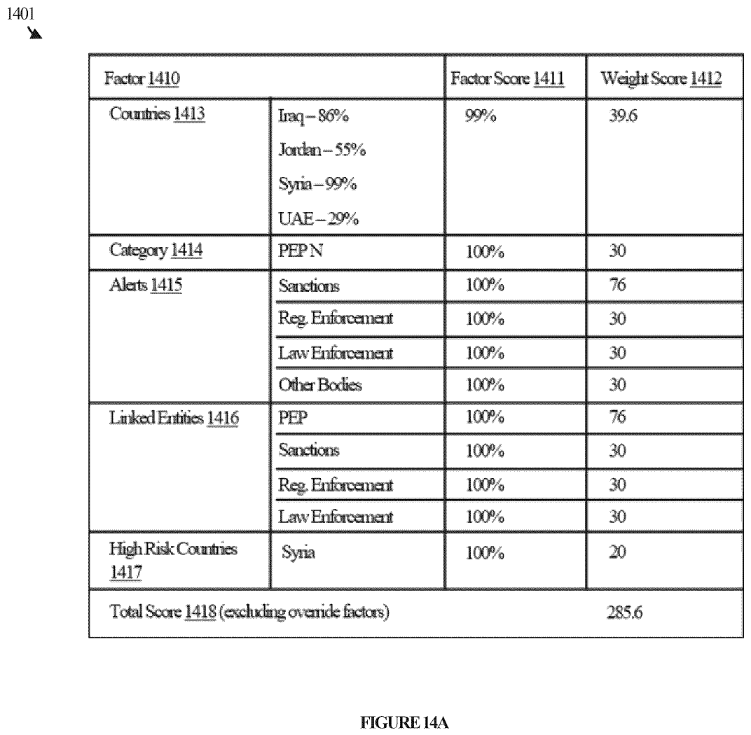

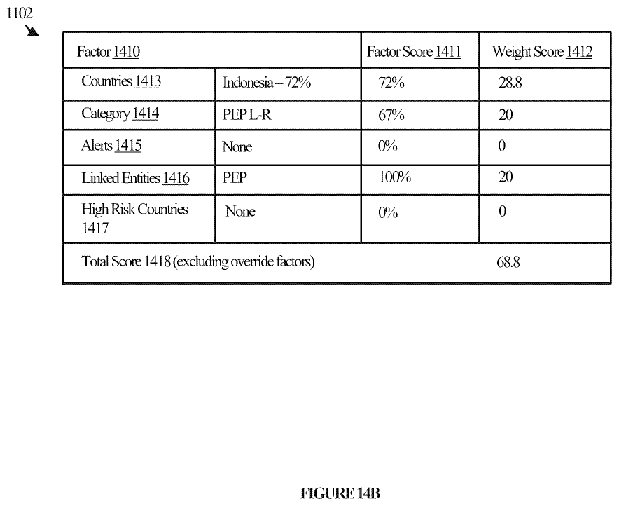

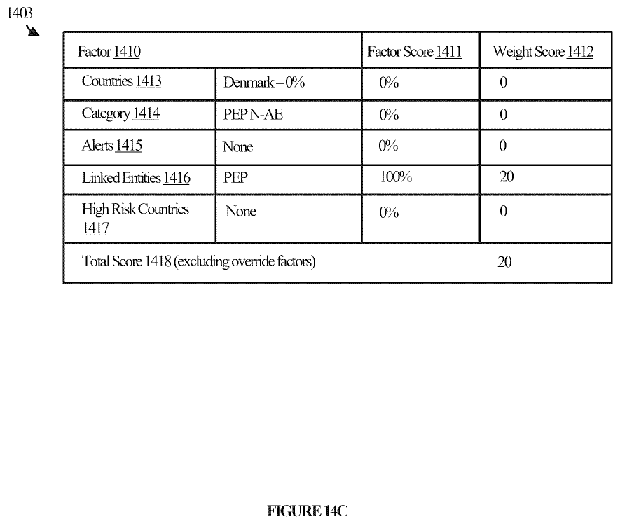

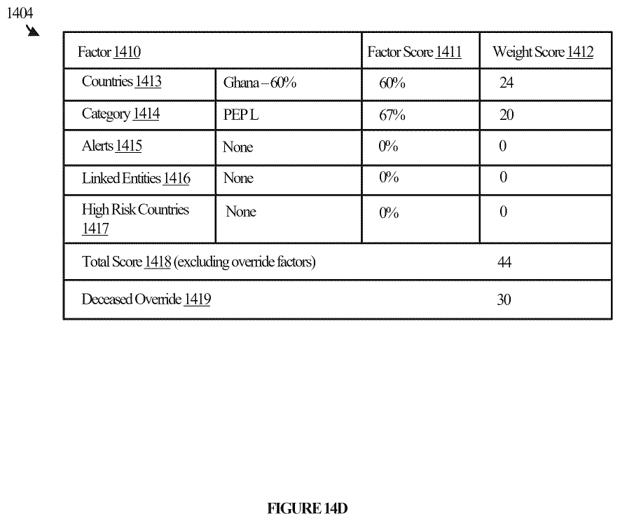

The following tables in FIGS. 14A, 14B, 14C, and 14D demonstrate examples of identified records in a sample PEP profile and corresponding scores based on weights 822 and modules 917 as applied against the records.

FIGS. 14A, 14B, 14C, and 14D illustrate example scoring tables and factors used in an implementation. FIG. 14A shows table 1401, FIG. 14B shows table 1402, FIG. 14C shows table 1403, and FIG. 14D shows table 1404, which may include scoring results produced by a scoring system (e.g., risk assessment platform 115) upon performing risk-based scoring techniques (e.g., method 201, method 202).

Table 1401 of FIG. 14A shows a first sample risk-based score for a first sample PEP profile. Table 1401 includes various factors 1410, breakdowns of factor score 1411 for each factor or record, breakdowns of weight score 1412 for each factor or record, and a total score 1418 that includes a combination of each weight score 1412. Factors 1410 may include countries 1413, PEP classification 1414, alerts 1415, linked entities 1416, and high-risk countries 1417.

In this example, the first sample PEP profile may include Iraq, Jordan, Syria, and United Arab Emirates under countries 1413. More specifically, Iraq may be identified as a country with a factor score 1411 of 86%, Jordan may be identified as a country with a factor score 1411 of 55%, Syria may be identified as a country with a factor score 1411 of 99%, and UAE may be identified as a country with a factor score 1411 of 29%. Based on these countries 1413, a scoring system may determine that the countries correspond to a factor score 1411 of 99% (the highest of any identified country). The scoring system may multiply the factor score 1411 with the maximum value of the weight (e.g., 40) to obtain a weight score 1412 of 39.6.

The PEP profile may include a national classification under PEP classification 1414. Based on a direct match to a classification in the first group of PEP classifications in table 602 of FIG. 6B, the scoring system may determine that the classification corresponds to a factor score 1411 of 100%, and thus, the full value of the weight score 1412 may be determined (e.g., 30) for this factor 1410.

The PEP profile may also include several indications corresponding to alerts 1415, such as a sanctions alert, a regulatory enforcement alert, a law enforcement alert, and an other bodies alert. Based on these indications and a match to an alert type, the scoring system may determine that the alerts each correspond to a factor score 1411 of 100%, and thus, the full value of each weight score 1412 may be determined. In this example, the sanctions alert may be flagged as an override factor and include a higher weight score 1412 than other factors.

The PEP profile may include several indications corresponding to linked entities 1416, such as a PEP classification linked entity, a sanctioned linked entity, a regulatory enforcement linked entity, and a law enforcement linked entity. Thus, the scoring system may determine that the linked entities correspond to a factor score 1411 of 100%, and the scoring system may award the full value of each weight score 1412 for each of the records under linked entities 1416.

Lastly, the PEP profile may include an indication of high-risk countries 1417, which may include Syria. Syria may be included in a first group of high-risk countries, which may correspond to a factor score 1411 of 100%, and thus, the scoring system may award the full value of weight score 1412 for the indication of high-risk countries 1417.

Based on factors 1410 and the weight score 1412 for each factor identified in the first sample PEP profile, the scoring system may calculate a total score 1418 of 285.6. The scoring system may compare total score 1418 to threshold scores, such as scores 411 of table 401 of FIG. 4, to determine whether the PEP is a high-risk PEP, a medium-risk PEP, or a low-risk PEP. Because total score 1418 exceeds the high range, the PEP of the first sample PEP profile may be identified as high-risk.

Table 1402 of FIG. 14B shows a second sample risk-based score for a second sample PEP profile. In this example, the second sample PEP profile may include Indonesia (a 72% factor score 1411) under countries 1413. Based on the countries 1413 and the percentage match thereof, a scoring system may determine that the countries correspond to a factor score 1411 of 72%. The scoring system may multiply the factor score 1411 by the maximum value of the weight (e.g., 40) to obtain a weight score 1412 of 28.8.

The PEP profile may include a local government immediate relative classification (PEP L-R) under PEP classification 1414. Based on a direct match to a classification in the second group of PEP classifications in table 1002 of FIG. 10B, the scoring system may determine that the classification corresponds to a factor score 1411 of 67%, and thus, 67% of the weight score 1412 may be determined (e.g., 20) for this factor 1410.

The PEP profile might not include any alerts 1415 or high-risk countries 1417.

However, the PEP profile may include an indication of a PEP classification under linked entities 1416, such that the scoring system may award 100% of the weight associated with linked entities 1416 (e.g., 20).

Based on factors 1410 and the weight score 1412 for each factor identified in the second sample PEP profile, the scoring system may calculate a total score 1418 of 68.8. The scoring system may compare total score 1418 to threshold scores, such as scores 411 of table 401 of FIG. 4, to determine whether the PEP is a high-risk PEP, a medium-risk PEP, or a low-risk PEP. Because total score 1418 exceeds the minimum score of the medium range but does not exceed the minimum score of the high range, the PEP of the second sample PEP profile may be identified as medium-risk.

Table 1403 of FIG. 14C shows a third sample risk-based score for a third sample PEP profile. In this example, the third sample PEP profile may include Denmark under countries 1413. Based on the countries 1413 and the percentage match thereof, a scoring system may determine that the countries correspond to a factor score 1411 of 0%. The scoring system may multiply the factor score 1411 by the maximum value of the weight (e.g., 40) to obtain a weight score 1412 of 0.

The PEP profile may include a subnational government immediate relative entity classification (PEP SN-R) under PEP classification 1414. Based on a direct match to a classification in the fourth group of PEP classifications in table 1002 of FIG. 10B, the scoring system may determine that the classification corresponds to a factor score 1411 of 0%, and thus, 0% of the weight score 1412 may be determined (e.g., 0) for this factor 1410.

The PEP profile might not include any alerts 1415 or high-risk countries 1417.

However, the PEP profile may include an indication of a PEP classification under linked entities 1416, such that the scoring system may award 100% of the weight associated with linked entities 1416 (e.g., 20).

Based on factors 1410 and the weight score 1412 for each factor identified in the second sample PEP profile, the scoring system may calculate a total score 1418 of 20. The scoring system may compare total score 1418 to threshold scores, such as scores 411 of table 401 of FIG. 4, to determine whether the PEP is a high-risk PEP, a medium-risk PEP, or a low-risk PEP. Because total score 1418 exceeds the minimum score of the low range but does not exceed the minimum score of the medium range, the PEP of the third sample PEP profile may be identified as low-risk.

Table 1404 of FIG. 14D shows a fourth sample risk-based score for a fourth sample PEP profile. In this example, the fourth sample PEP profile may include Ghana under countries 1413. Based on the countries 1413 and the percentage match thereof, a scoring system may determine that the countries correspond to a factor score 1411 of 60%. The scoring system may multiply the factor score 1411 by the maximum value of the weight (e.g., 40) to obtain a weight score 1412 of 24.

The PEP profile may include a local government classification (PEP L) under PEP classification 1414. Based on a direct match to a classification in the second group of PEP classifications in table 602 of FIG. 6B, the scoring system may determine that the classification corresponds to a factor score 1411 of 67%, and thus, 67% of the weight score 1412 may be determined (e.g., 20) for this factor 1410. The PEP profile might not include any alerts 1415, linked entities 1416, or high-risk countries 1417.

Based on factors 1410 and the weight score 1412 for each factor identified in the second sample PEP profile, the scoring system may calculate a total score 1418 of 44. The scoring system may compare total score 1418 to threshold scores, such as scores 411 of table 401 of FIG. 4, to determine whether the PEP is a high-risk PEP, a medium-risk PEP, or a low-risk PEP. Because total score 1418 exceeds the minimum score of the medium range but does not exceed the minimum score of the high range, the PEP of the fourth sample PEP profile may be identified as medium-risk. However, the PEP profile may further include a factor 1410 indicative that the PEP is deceased, which may be referred to as deceased override 1419. Because the PEP is deceased, a weight score 1412 having a value of 30 may be deducted from total score 1418, and thus, the PEP may ultimately be classified as low-risk.

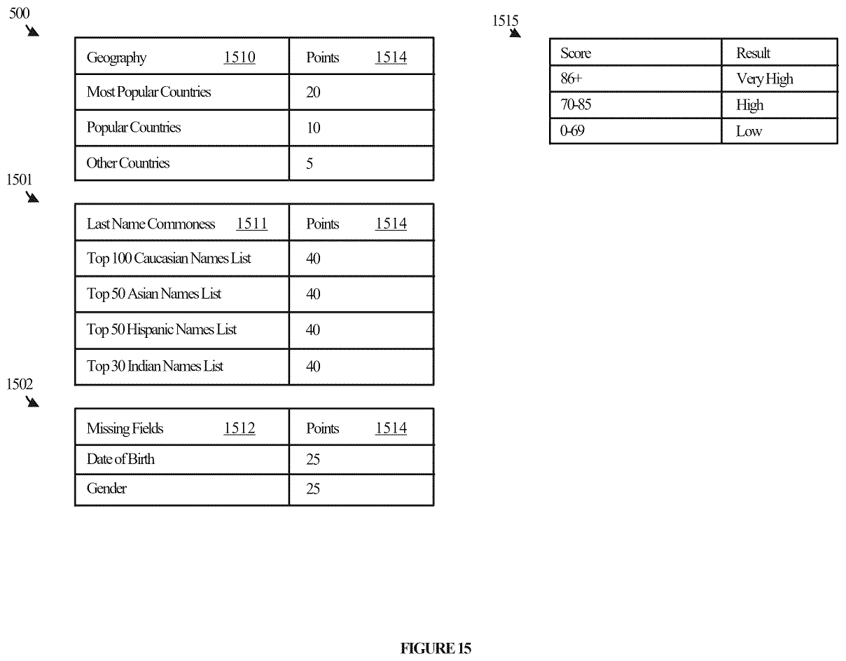

Referring next to FIG. 15, FIG. 15 illustrates an example scoring table related to determining a false positive probability score used in an implementation. FIG. 15 shows table 1500, which may include data parameters and weights assigned thereto for use by a scoring system (e.g., risk assessment platform 115) when performing risk-based scoring techniques (e.g., method 201, method 202).

Table 1500 includes geography factors 1510 and corresponding points 1514, commonness of last name factors 1511 and corresponding points 1514, and missing factors 1512 and corresponding points 1514. The factors and points 1514 may be used by a risk assessment platform (e.g., risk assessment platform 115) to generate a false positive probability score, among other scores.

Geography factors 1510 may include various groups of countries that correspond to different amounts of points 1514. For example, geography factors 1510 may include a first group of countries including China, India, the United States of America, and Canada. A PEP including an indication of one of these countries may be associated with a point value of 20.

Geography factors 1510 may include a second group of countries including Indonesia, Pakistan, Nigeria, Brazil, Bangladesh, Russia, and Mexico. A PEP including an indication of one of these countries may be associated with a point value of 10. Geography factors 1510 may include a third group including all other countries, which may be associated with a point value of 5.

Commonness of last name factors 1511 may include various groups of last names based on ethnicity that each correspond to a different amount of points 1514. In various embodiments, a PEP including an indication of a last name in any of the groups identified in a common last name data set may be associated with a point value of 40. Examples of the groups within commonness of last name factors 1511 include 100 most common traditionally white names, 50 most common Asian names, 50 most common Hispanic names, and 30 most common Indian names. Other ethnic groups and numbers of last names may be contemplated.

Missing factors 1512 may include groups of factors that correspond to different amounts of points 1514. For example, missing factors 1512 may include a first group including date of birth. For a PEP profile including an indication that the PEP profile is missing the date of birth of an individual, a scoring system may assign 25 points to a false positive probability score associated with the PEP profile. Missing factors 1512 may also include a second group including gender. For a PEP profile including an indication that the PEP profile is missing the gender of an individual, a scoring system may assign 25 points to the false positive probability score associated with the PEP profile.

Following analysis of the factors and records of a PEP profile, a scoring system may total the number of points 1514 associated with the PEP profile to generate a false positive probability score for the PEP profile. It follows that the higher the false positive probability score, the stronger the probability that a PEP profile is a false positive. The scoring system can compare the false positive probability score with a threshold scoring scale 1515. In some embodiments, a score of 86 points or higher may be indicated as very high, a score between 70 points and 85 points may be indicated as high, and a score of 69 points and below may be indicated as lower than high or very high. The scoring system may provide indications of the false positive probability score per PEP profile to a user device (e.g., user device 120) for display on a user interface (e.g., user interface 1100) of the user device. Further, the scoring system may group PEP profiles into queues based on false positive probability scores.

In some embodiments, additional, fewer, or different factors, point values, and/or threshold scoring scales may be used by a scoring system in producing false positive probability scores associated with PEP profiles.

FIG. 16 illustrates computing system 1601 to perform risk assessment, risk analysis, threat level computation and categorization, and false positive probability computation and categorization, among other risk assessment and entity evaluation processes according to an implementation of the present technology. Computing system 1601 is representative of any system or collection of systems with which the various operational architectures, processes, scenarios, and sequences disclosed herein for risk assessment and related operations may be employed. Computing system 1601 may be implemented as a single apparatus, system, or device or may be implemented in a distributed manner as multiple apparatuses, systems, or devices. Computing system 1601 includes, but is not limited to, processing system 1602, storage system 1603, software 1605, communication interface system 1607, and user interface system 1609 (optional). Processing system 1602 is operatively coupled with storage system 1603, communication interface system 1607, and user interface system 1609. Computing system 1601 may be representative of a cloud computing device, distributed computing device, or the like.

Processing system 1602 loads and executes software 1605 from storage system 1603. Software 1605 includes and implements risk assessment process 1606, which is representative of any of the data analyzing, sorting, evaluating, normalizing, standardizing, weighting, scoring, categorization, configuring, and visualizing processes discussed with respect to the preceding Figures. When executed by processing system 1602 to provide risk assessment functions, software 1605 directs processing system 1602 to operate as described herein for at least the various processes, operational scenarios, and sequences discussed in the foregoing implementations. Computing system 1601 may optionally include additional devices, features, or functionality not discussed for purposes of brevity.

Referring still to FIG. 16, processing system 1602 may comprise a micro-processor and other circuitry that retrieves and executes software 1605 from storage system 1603. Processing system 1602 may be implemented within a single processing device but may also be distributed across multiple processing devices or sub-systems that cooperate in executing program instructions. Examples of processing system 1602 include general purpose central processing units, graphical processing units, application specific processors, and logic devices, as well as other processing devices and combinations or variations thereof.

Storage system 1603 may comprise any computer readable storage media readable by processing system 1602 and capable of storing software 1605. Storage system 1603 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media.

In no case is the computer readable storage media a propagated signal.

In addition to computer readable storage media, in some implementations storage system 1603 may also include computer readable communication media over which at least some of software 1605 may be communicated internally or externally. Storage system 1603 may be implemented as a single storage device but may also be implemented across multiple storage devices or sub-systems co-located or distributed relative to each other. Storage system 1603 may comprise additional elements, such as a controller, capable of communicating with processing system 1602 or possibly other systems.

Software 1605 (including risk assessment process 1606) may be implemented in program instructions and among other functions may, when executed by processing system 1602, direct processing system 1602 to operate as described with respect to the various operational scenarios, sequences, and processes illustrated herein. For example, software 1605 may include program instructions for implementing risk assessment processes as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1605 may include additional processes, programs, or components, such as operating system software, virtualization software, or other application software. Software 1605 may also comprise firmware or some other form of machine-readable processing instructions executable by processing system 1602.

In general, software 1605 may, when loaded into processing system 1602 and executed, transform a suitable apparatus, system, or device (of which computing system 1601 is representative) overall from a general-purpose computing system into a special-purpose computing system customized to provide memory allocation as described herein. Indeed, encoding software 1605 on storage system 1603 may transform the physical structure of storage system 1603. The specific transformation of the physical structure may depend on various factors in different implementations of this description. Examples of such factors may include, but are not limited to, the technology used to implement the storage media of storage system 1603 and whether the computer-storage media are characterized as primary or secondary storage, as well as other factors.

For example, if the computer readable storage media are implemented as semiconductor-based memory, software 1605 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1607 may include communication connections and devices that allow for communication with other computing systems (not shown) over communication networks (not shown). Examples of connections and devices that together allow for inter-system communication may include network interface cards, antennas, power amplifiers, radiofrequency circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 1601 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of networks, or variation thereof. The aforementioned communication networks and protocols are well known and need not be discussed at length here.

While some examples provided herein are described in the context of a risk assessment platform, system, apparatus, device, environment, server, or service, the risk assessment and analysis methods, techniques, systems, and devices described herein are not limited to such examples and may apply to a variety of other processes, systems, applications, devices, and the like. As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The phrases “in some examples,” “according to some examples,” “in the examples shown,” “in other examples,” and the like generally mean the particular feature, structure, or characteristic following the phrase is included in at least one implementation of the present technology, and may be included in more than one implementation. In addition, such phrases do not necessarily refer to the same example or different examples.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology.

Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A risk assessment platform comprising:
one or more computer-readable storage media;
program instructions stored on the one or more computer-readable storage media that, based on being read and executed by a processing device, direct the processing device to:
receive an input comprising an indication of a target entity subject to a risk assessment;
identify, based on the input, multiple possible instances of the target entity from a database including a plurality of entities;
for each possible instance of the multiple possible instances, evaluate a strength of a match of the possible instance relative to the target entity based on applying a set of criteria against the indication of the target entity, applying the set of criteria against an indication of the possible instance, and comparing results of the applications of the set of criteria;
display, on a graphical user interface, a visual representation of the multiple possible instances and corresponding strengths of matches; and
in response to a selection of one or more of the multiple possible instances, add the one or more of the multiple possible instances to a queue associated with a further risk assessment.

2. The risk assessment platform of claim 1, wherein the indication of the target entity comprises personal information and geographical information associated with the target entity.

3. The risk assessment platform of claim 2, wherein:
the set of criteria includes sets of weights applicable to the personal information and the geographical information associated with the target entity;
a first set of weights of the sets of weights corresponds to a commonness of a surname identified in the indications of the target entity and the multiple possible instances; and
a second set of weights of the sets of weights corresponds to a popularity of a domicile identified in the indications of the target entity and the multiple possible instances.

4. The risk assessment platform of claim 3, wherein to apply the set of criteria against the indication of the target entity, the program instructions direct the processing device to:
access a first database and obtain common surname data from the first database, wherein the common surname data includes lists of common surnames for multiple ethic groups;
determine the first set of weights for the common surname data;
access a second database and obtain popular country data from the second database;
determine the second set of weights for the popular country data; and
generate the strengths of matches for the multiple possible instances of the target entity based on applying the first and second sets of weights to surnames and domiciles derived from the indications of the target entity and the multiple possible instances.

5. The risk assessment platform of claim 4, wherein, for each possible instance, evaluating the strength of a match for the possible instance comprises identifying a combination of a missing date of birth and a missing gender in the indication of the possible instance and applying a weight based on the combination to the results of the application of the criteria.

6. The risk assessment platform of claim 1, wherein the program instructions further direct the processing device to, in response to a dismissal input of one or more other possible instances of the multiple possible instances, updating metadata associated with the one or more other possible instances to indicate the one or more other possible instances as false positive instances with respect to the target entity.

7. A risk assessment platform comprising:
one or more computer-readable storage media;
program instructions stored on the one or more computer-readable storage media that, based on being read and executed by a processing device, direct the processing device to:
receive an input comprising an indication of a target entity subject to a risk assessment;
identify, based on the input, multiple possible instances of the target entity from a database including a plurality of entities;
display, on a graphical user interface, a visual representation of the multiple possible instances, corresponding strengths of matches relative to the target entity, and corresponding risk profiles; and
in response to a selection of a risk profile of one of the multiple possible instances, display, on the graphical user interface, a visual representation of a risk assessment generated for the risk profile based on performing a risk analysis on data associated with the risk profile accessed through one or more databases, wherein the visual representation of the risk assessment includes an indication of a threat confidence level associated with the risk profile.

8. The risk assessment platform of claim 7, wherein the indication of the target entity comprises personal information and geographical information associated with the target entity.

9. The risk assessment platform of claim 7, wherein the program instructions direct the processing device to determine the strengths of matches of the multiple possible instances relative to the target entity based on applying a set of criteria against the indication of the target entity and comparing results of the application of the set of criteria with the indications of the multiple possible instances.

10. The risk assessment platform of claim 7, wherein the data associated with the risk profile comprises corruption perception index data and politically-exposed persons data.

11. The risk assessment platform of claim 10, wherein to perform the risk analysis on the data, the program instructions direct the processing device to:
identify a subset of records of the data having associated values;
convert the values associated with the subset of records from a first format to a second format; and
generate sets of weights for the data, wherein the sets of weights comprises a first set of weights including the converted values, and a second set of weights; and
apply the sets of weights to the data.

12. The risk assessment platform of claim 7, wherein the threat confidence level corresponds to a level of confidence of corruption with respect to performing financial transactions with the entity.

13. The risk assessment platform of claim 12, wherein the program instructions direct the processing device to output an alert indication based on determining that the threat confidence level exceeds a threshold level.

14. The risk assessment platform of claim 7, wherein the program instructions direct the processing device to, in response to a confirmation input of a risk profile, add the risk profile to a queue associated with risk profiles subject to further risk assessment.

15. A risk assessment system comprising:
a memory; and
a processor coupled with executable instructions forming modules of the risk assessment system and configured to execute the modules of the risk assessment system to produce a risk assessment, wherein the modules executed by the processor include:
an input interface configured to obtain, from one or more databases, risk and governance data associated with an entity subject to the risk assessment, and obtain, from a user device, an input comprising an indication of a target entity;
an output interface configured to output the risk assessment of the target entity;
a data processing module configured to:
receive the risk and governance data associated with the target entity from the input interface and identify a subset of records having associated values;
convert the values associated with the subset of records of the risk and governance data from a first format to a second format; and
provide the converted values to a weight generation module;
the weight generation module configured to:
receive the risk and governance data and the converted values from the data processing module;
generate a set of weights for the risk and governance data, wherein the set of weights comprises a first subset of weights including the converted values, and a second subset of weights; and
provide the set of weights to a scoring module; and
the threat detection module configured to:
generate the risk assessment of the target entity based on applying the set of weights to the risk and governance data; and
provide the risk assessment to the output interface.

16. The risk assessment system of claim 15, wherein the risk assessment includes a threat confidence level associated with the risk profile, and wherein the threat confidence level corresponds to a level of confidence of corruption with respect to performing financial transactions with the entity.

17. The risk assessment system of claim 16, wherein the output interface is further configured to output an alert indication responsive to determining that the threat confidence level exceeds a threshold level.

18. The risk assessment system of claim 16, wherein the modules executed by the processor further include a visualization module configured to receive the risk assessment and display, on a graphical user interface, a visual representation of a risk assessment including a visual indication of the threat confidence level.

19. The risk assessment system of claim 15, wherein the modules executed by the processor further include a false positive analyzer module configured to:
receive the risk and governance data associated with the entity from the input interface;
identify multiple possible instances of the target entity from the risk and governance data;
for each possible instance of the multiple possible instances, evaluate a strength of a match of the possible instance to the target entity based on applying a set of criteria against the indication of the target entity and comparing results of the application of the set of criteria with an indication of the possible instance; and
for each possible instance of the multiple possible instances having a strength of a match below a threshold level, update metadata of the possible instance to indicate the possible instance as a false positive instance with respect to the target entity.

20. The risk assessment system of claim 19, wherein the modules executed by the processor further include a visualization module configured to receive indications of the strengths of matches of the multiple possible instances and display, on a graphical user interface, indications of the multiple possible instances and the indications of the strengths of matches.
